(19) United States
(12) Patent Application Publication
(10) Pub. No.: US 2024/0393527 A1
(43) Pub. Date: Nov. 28, 2024

(54) THREE-LAYER THIN-COATED FIBER HAVING IMPROVED DAMAGE RESISTANCE

(71) Applicant: CORNING INCORPORATED, CORNING, NY (US)

(72) Inventors: Donald Arthur Clark, Corning, NY (US); Matthew Ryan Drake, Big Flats, NY (US); Yunfeng Gu, Painted Post, NY (US); Ming-Jun Li, Horseheads, NY (US); Joseph Edward McCarthy, Hornell, NY (US); Weijun Niu, Painted Post, NY (US)

(21) Appl. No.: 18/662,275

(22) Filed: May 13, 2024

Related U.S. Application Data
(60) Provisional application No. 63/469,082, filed on May 26, 2023.

(51) Int. Cl. G02B 6/02

(52) U.S. Cl. CPC G02B 6/02395

(57) ABSTRACT

An optical fiber includes a glass core, a glass cladding surrounding and in direct contact with the glass core, and a coating surrounding and in direct contact with the glass cladding. The coating includes three layers, a first high-modulus coating layer having a Young's modulus greater than 500 MPa, a second high-modulus coating layer having a Young's modulus greater than 500 MPa, and a low-modulus coating layer having a Young's modulus between about 0.20 MPa and 5 MPa. The coating may have the first high-modulus coating layer as the inner layer, the low-modulus coating layer as the intermediate layer, and the second high-modulus coating layer as the outer layer. Alternatively, the coating may have the low-modulus coating layer as the inner layer, first high-modulus coating layer as the intermediate layer, and the second high-modulus coating layer as the outer layer.

This application claims the benefit of priority under 35 U.S.C § 120 of U.S. Provisional Application Ser. No. 63/469,082 filed on May 26, 2023, the content of which is relied upon and incorporated herein by reference in its entirety.

### FIELD OF THE DISCLOSURE

The present disclosure generally relates to optical fibers, and more particularly relates to a three-layer thin coated fiber having improved damage resistance.

### BACKGROUND OF THE DISCLOSURE

Optical fibers are widely used in telecommunications applications. Optical fibers having small cladding and coating diameters are attractive for reducing the size of cables, decreasing cable costs and increasing the bandwidth density of optical interconnects. It has become desirable to use thinner coating layers to make the overall diameter of optical fibers smaller while improving or maintaining damage resistance.

### SUMMARY OF THE DISCLOSURE

The present disclosure addresses reducing the overall diameter of the optical fibers in several ways. The present disclosure reduces the overall diameter of the optical fiber by having a three-layer coating with two high-modulus coating layers and a low-modulus coating layer. In one instance the first high-modulus coating layer is surrounding a glass fiber having a core and cladding, the low-modulus coating layer is surrounding the first high-modulus coating layer, and the second high-modulus coating layer is surrounding the low-modulus coating layer. In a second instance the low-modulus coating layer is surrounding the glass fiber, the first high-modulus coating layer is surrounding the low-modulus coating layer, and the second high-modulus coating layer is surrounding the first high-modulus coating layer. The outer diameter of the optical fiber is able to be reduced by minimizing the thickness of each of the three layers thereby reducing the total coating thickness compared to traditional two-layer optical fibers that have an inner low-modulus layer and an outer high-modulus layer. The reduced diameter three-layer optical fiber is able to maintain a similar, or sometimes greater, final failure puncture load compared to the larger diameter traditional two-layer optical fiber. These solutions allow for optical fibers to have a reduced diameter while maintaining, and in some cases improving, the puncture load and damage resistance of the fiber.

According to a first aspect of the present disclosure, the optical fiber comprises: a glass core, a glass cladding surrounding and in direct contact with the glass core, and a coating surrounding and in direct contact with the glass cladding where the coating includes, a first high-modulus coating layer having a Young's modulus greater than 500 MPa, a second high-modulus coating layer having a Young's modulus greater than 500 MPa, and a low-modulus coating layer having a Young's modulus between about 0.20 MPa and 5 MPa, wherein an outer circumference of the optical fiber has a diameter less than about 200 μm.

According to a second aspect of the present disclosure, wherein an outer circumference of the optical fiber has a diameter of less than about 180 μm.

According to third aspect of the present disclosure, wherein the outer circumference of the optical fiber has a diameter from about 160 μm to about 170 μm.

According to a fourth aspect of the present disclosure, wherein at least one of the first high-modulus coating layer, the second high-modulus coating layer, and the low-modulus coating layer is a radially innermost coating layer that is directly adjacent the glass cladding, the radially innermost coating layer being the thinnest coating layer.

According to a fifth aspect of the present disclosure, wherein the optical fiber has an attenuation at 1310 nm wavelength of about 0.50 dB/km or less and a cable cutoff of about 1260 nm or less.

According to a sixth aspect of the present disclosure, wherein the attenuation at 1310 nm wavelength is about 0.40 dB/km or less.

According to a seventh aspect of the present disclosure, wherein the attenuation at 1310 nm wavelength is about 0.35 dB/km or less.

According to an eighth aspect of the present disclosure, wherein the attenuation at 1310 nm wavelength is from about 0.50 dB/km to about 0.25 dB/km.

According to a ninth aspect of the present disclosure, wherein the cable cutoff is about 1225 nm or less.

According to a tenth aspect of the present disclosure, wherein the optical fiber has an attenuation at 1550 nm wavelength of about 0.50 dB/km or less.

According to an eleventh aspect of the present disclosure, wherein the attenuation at 1550 nm wavelength is about 0.30 dB/km or less.

According to a twelfth aspect of the present disclosure, wherein the attenuation at 1550 nm wavelength is about 0.25 dB/km or less.

According to a thirteenth aspect of the present disclosure, wherein the attenuation at 1550 nm wavelength is from about 0.50 dB/km to about 0.15 dB/km.

According to a fourteenth aspect of the present disclosure, wherein the optical fiber has a mode field diameter at 1310 nm wavelength of about 8.2 μm or greater.

According to a fifteenth aspect of the present disclosure, wherein the mode field diameter at 1310 nm wavelength is from about 8.2 μm to about 9.7 μm.

According to a sixteenth aspect of the present disclosure, wherein the optical fiber has an effective area at 1310 nm wavelength from about 54.0 micron² to about 70.0 micron².

According to a seventeenth aspect of the present disclosure, wherein the effective area at 1310 nm wavelength is from about 58.0 micron² to about 68.0 micron².

According to an eighteenth aspect of the present disclosure, wherein the first high-modulus coating layer is surrounding and in direct contact with the glass cladding, the low-modulus coating layer is surrounding and in direct contact with the first high-modulus coating layer, and the second high-modulus coating layer is surrounding and in direct contact with the low-modulus coating layer.

According to a nineteenth aspect of the present disclosure, wherein the first high-modulus coating layer has a thickness of less than about 10 μm, the low-modulus coating layer has a thickness of less than about 17.5 μm, and the second high-modulus coating layer has a thickness of less than about 25 μm.

According to a twentieth aspect of the present disclosure, wherein the first high-modulus coating layer comprises a cured product that includes a monomer, a photoinitiator, a slip agent, and an adhesion promoter.

According to a twenty-first aspect of the present disclosure, wherein the low-modulus coating layer comprises a cured product that includes a monomer and a photoinitiator.

According to a twenty-second aspect of the present disclosure, wherein the second high-modulus coating layer comprises a cured product that includes a monomer, a photoinitiator, and a slip agent.

According to a twenty-third aspect of the present disclosure, wherein the first high-modulus coating layer includes between about 0.3 pph to about 5 pph of silane.

According to a twenty-fourth aspect of the present disclosure, the optical fiber has a final failure puncture load between about 25 g and 125 g.

According to a twenty-fifth aspect of the present disclosure, wherein the low-modulus coating layer is surrounding and in direct contact with the glass cladding, the first high-modulus coating layer is surrounding and in direct contact with the low-modulus layer, and the second high-modulus coating layer is surrounding and in direct contact with the first high-modulus coating layer.

According to a twenty-sixth aspect of the present disclosure, wherein the low-modulus coating layer has a thickness of less than about 15 μm, the first high-modulus coating layer has a thickness of less than about 20 μm, and the second high-modulus coating layer has a thickness of less than about 25 μm.

According to a twenty-seventh aspect of the present disclosure, wherein the first high-modulus coating layer has a first composition, and the second high-modulus coating layer has a second composition, wherein the first composition is different from the second composition.

According to a twenty-eighth aspect of the present disclosure, wherein the first composition includes a monomer, a photoinitiator, and slip agent, and the second composition includes a monomer, a photoinitiator, and slip agent.

According to a twenty-ninth aspect of the present disclosure, wherein the second high-modulus coating layer has a higher Young's modulus than the first high-modulus coating layer.

According to a thirtieth aspect of the present disclosure, wherein the low-modulus coating layer comprises a cured product that includes a monomer, a photoinitiator, and an adhesion promoter.

According to a thirty-first aspect of the present disclosure, wherein the optical fiber has a final failure puncture load between about 25 g and 125 g.

According to a thirty-second aspect of the present disclosure, the optical fiber comprise: a glass core, a glass cladding surrounding and in direct contact with the glass core, and a coating, where the coating includes: a first coating layer surrounding and in direct contact with the glass cladding, the first coating layer having a thickness of less than 10 μm and a Young's modulus greater than 500 MPa, a second coating layer surrounding and in direct contact with the first coating layer, the second coating layer having a thickness of less than 17.5 μm and a Young's modulus between about 0.20 MPa and 5 MPa, and a third coating layer surrounding and in direct contact with the second coating layer, the third coating layer having a thickness of less than 25 μm and a Young's modulus greater than 500 MPa.

According to a thirty-third aspect of the present disclosure, wherein the first coating layer is thinner than either of the second coating layer and the third coating layer.

According to a thirty-fourth aspect of the present disclosure, wherein the glass core and the glass cladding defining a glass fiber, and an outer circumference of the glass fiber having a diameter between about 100 μm to 125 μm.

According to a thirty-fifth aspect of the present disclosure, wherein an outer circumference of the optical fiber has a diameter less than about 200 μm.

According to a thirty-sixth aspect of the present disclosure, wherein the outer circumference of the optical fiber has a diameter of less than about 180 μm.

According to a thirty-seventh aspect of the present disclosure, wherein the outer circumference of the optical fiber has a diameter of about 160 μm to about 170 μm.

According to a thirty-eighth aspect of the present disclosure, wherein the optical fiber has a final failure puncture load between about 30 g and 100 g.

According to a thirty-ninth aspect of the present disclosure, the optical fiber comprises: a glass core, a glass cladding surrounding and in direct contact with the glass core, and, a coating, where the coating includes a first coating layer surrounding and in direct contact with the glass cladding, the first coating layer having a thickness of less than 15 μm and a Young's modulus between about 0.20 MPa and 5 MPa, a second coating layer surrounding and in direct contact with the first coating layer, the second coating layer having a thickness of less than 20 μm and a Young's modulus greater than 500 MPa, and a third coating layer surrounding and in direct contact with the second coating layer, the third coating layer having a thickness of less than 25 μm and a Young's modulus greater than 500 MPa and the Young's modulus of the second coating layer.

According to a fortieth aspect of the present disclosure, wherein the first coating layer is thinner than either of the second coating layer and the third coating layer.

According to a forty-first aspect of the present disclosure, wherein an outer circumference of the optical fiber has a diameter less than about 200 μm.

According to a forty-second aspect of the present disclosure, wherein the outer circumference of the optical fiber has a diameter of less than about 180 μm.

According to a forty-third aspect of the present disclosure, wherein the outer circumference of the optical fiber has a diameter of about 160 μm to about 170 μm.

According to a forty-fourth aspect of the present disclosure, wherein the second coating layer has a first composition, and the third coating layer has a second composition, wherein the first composition is different from the second composition.

According to a forty-fifth aspect of the present disclosure, wherein the first coating layer comprises a cured product that includes a monomer, a photoinitiator, and an adhesion promoter.

According to a forty-sixth aspect of the present disclosure, wherein the optical fiber has a final failure puncture load between about 25 g and 75 g.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the drawings:

FIG. 1 is a schematic view of a coated optical fiber having a three-layer coating according to one embodiment;

FIG. 2 is a schematic view of a profile design for a single mode fiber;

FIG. 3 is a schematic view of a coated optical fiber having a three-layer coating according to a second embodiment;

FIG. 4 is a first puncture resistance load curve for a comparative example of a two-layered coated optical fiber;

FIG. 5 is a second puncture load curve for a comparative example of a two-layered coated optical fiber;

FIG. 6 is a puncture load curve for an exemplary example one of a three-layered optical fiber;

FIG. 7 is a puncture load curve for an exemplary example two of a three-layered optical fiber;

FIG. 8 is a puncture load curve for an exemplary example three of a three layered optical fiber;

FIG. 9 is a puncture load curve for an exemplary example four of a three layered optical fiber; and

FIG. 10 shows the stress triaxiality vs. puncture force of an exemplary example and a comparative example.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims which follow, reference will be made to a number of terms which shall be defined to have the following meanings:

“Include,” “includes,” or like terms means encompassing but not limited to, that is, inclusive and not exclusive.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

In some embodiments, the term “about” references terms or endpoints in a range. For example, about 1, 2, or 3 is equivalent to about 1, about 2, or about 3, and further comprises from about 1 to 3, from about 1 to 2, and from about 2 to 3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, “comprising” is an open-ended transitional phrase. A list of elements following the transitional phrase “comprising” is a non-exclusive list, such that elements in addition to those specifically recited in the list may also be present.

The term “wherein” is used as an open-ended transitional phrase, to introduce a recitation of a series of characteristics of the structure.

The terms “comprising,” and “comprises,” e.g., “A comprises B,” is intended to include as special cases the concepts of “consisting” and “consisting essentially of” as in “A consists of B” or “A consists essentially of B”.

The term “or,” as used herein, is inclusive; more specifically, the phrase “A or B” means “A, B, or both A and B.” Exclusive “or” is designated herein by terms such as “either A or B” and “one of A or B,” for example.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other but are rigidly or flexibly joined through one or more intervening materials. Contacting refers to placing two elements in direct or indirect contact. Elements in direct (indirect) contact may be said to directly (indirectly) contact each other.

As used herein, “directly adjacent” means directly contacting and “indirectly adjacent” mean indirectly contacting. The term “adjacent” encompasses elements that are directly or indirectly adjacent to each other. The term “directly surrounds” means “surrounding and directly adjacent to.”

“Optical fiber” refers to a waveguide having a glass portion surrounded by a coating. The glass portion includes a core and a cladding and is referred to herein as a “glass fiber.”

“Radial position”, “radius”, or the radial coordinate “r” refers to radial position relative to the centerline (r=0) of the fiber.

The terms “inner” and “outer” are used to refer to relative values of radial coordinate or relative positions of regions of the optical fiber, where “inner” means closer to the centerline of the fiber than “outer.” An inner radial coordinate is closer to the centerline of the glass fiber than an outer radial coordinate. An inner radial coordinate is between the centerline of the glass fiber and an outer radial coordinate. An inner region of an optical fiber is closer to the centerline of the glass fiber than an outer region. An inner region of an optical fiber is between the centerline of the glass fiber and the outer region of the glass fiber.

The term “μm” or “micron” means micrometer; that is, 10⁻⁶ m.

Megapascal (MPa) is the customary unit used when referring to Young's modulus.

The term “attenuation,” as used herein, is the loss of optical power as the signal travels along the optical fiber. Attenuation was measured as specified by the IEC-60793-1-40 standard, “Attenuation measurement methods.”

“Cable cutoff wavelength,” or “cable cutoff,” as used herein, refers to the 22 m cable cutoff test as specified by the IEC 60793-1-44 standard, “Measurement methods and test procedures—Cut-off wavelength.”

The “mode field diameter” or “MFD” of an optical fiber is defined in Eq. (1) as:

$$MFD = 2 w \qquad ( 1 )$$

$${w}^{2} = 2 \frac{{\int }_{0}^{∞} {( f ( r ) )}^{2} r d r}{{\int }_{0}^{∞} {( \frac{d f ( r )}{d r} )}^{2} r d r}$$

where f(r) is the transverse component of the electric field distribution of the guided optical signal and r is radial position in the fiber. “Mode field diameter” or “MFD” depends on the wavelength of the optical signal and may be reported herein for wavelengths of 1310 nm, 1550 nm, and 1625 nm. Specific indication of the wavelength will be made when referring to mode field diameter herein. Unless otherwise specified, mode field diameter refers to the LP₀₁ mode at the specified wavelength.

“Refractive index” refers to the refractive index at a wavelength of 1550 nm, unless otherwise specified.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ%) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined by Eq. (2) below, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (2) as:

$${Δ}_{i} ( {r}_{i} ) \% = 100 \frac{( {n}_{i}^{2} - {n}_{ref}^{2} )}{2 {n}_{i}^{2}} \qquad ( 2 )$$

where nᵢ is the refractive index at radial position rᵢ in the glass fiber, unless otherwise specified, and n_{ref} is the refractive index of pure silica glass, unless otherwise specified. Accordingly, as used herein, the relative refractive index percent is relative to pure silica glass, which has a value of 1.444 at a wavelength of 1550 nm. As used herein, the relative refractive index is represented by Δ (or “delta”) or Δ% (or “delta %) and its values are given in units of “%”, unless otherwise specified. Relative refractive index may also be expressed as Δ(r) or Δ(r) %.

The average relative refractive index (Δₐᵥₑ) of a region of the fiber is determined from Eq. (3):

$${Δ}_{a v e} = {\int }_{{r}_{i n n e r}}^{{r}_{o u t e r}} \frac{Δ ( r ) dr}{( {r}_{o u t e r} - {r}_{i n n e r} )} \qquad ( 3 )$$

where rᵢₙₙₑᵣ is the inner radius of the region, rₒᵤₜₑᵣ is the outer radius of the region, and Δ(r) is the relative refractive index of the region.

The refractive index of an optical fiber profile may be measured using commercially available devices, such as the IFA-100 Fiber Index Profiler (Interfiber Analysis LLC, Sharon, Mass. USA) or the S14 Refractive Index Profiler (Photon Kinetics, Inc., Beaverton, Oreg. USA). These devices measure the refractive index relative to a measurement reference index, n(r)−nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined by Eq. (2).

The term “α-profile” or “alpha profile” refers to a relative refractive index profile Δ(r) that has the functional form defined in Eq. (4):

$$Δ ( r ) = Δ ( {r}_{0} ) [ 1 - {[ \frac{\vert r - {r}_{0} \vert}{( {r}_{z - {r}_{0}} )} ]}^{a} ] \qquad ( 4 )$$

where rₒ is the radial position at which Δ(r) is maximum, Δ(r₀)>0, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and α is a real number. Δ(r₀) for an α-profile may be referred to herein as Δₘₐₓ or, when referring to a specific region i of the fiber, as Δᵢₘₐₓ. When the relative refractive index profile of the fiber core region is described by an α-profile with r₀ occurring at the centerline (r=0), r_{z} corresponding to the outer radius r₁ of the core region, and Δ₁(r₁)=0, Eq. (4) simplifies to Eq. (5):

$${Δ}_{1} ( r ) = {Δ}_{1 max} [ 1 - {[ \frac{r}{{r}_{1}} ]}^{a} ] \qquad ( 5 )$$

Reference will now be made in detail to the present preferred embodiments, examples of which are illustrated in the accompanying drawings.

One embodiment relates to a coated optical fiber having three coating layers. An example of a three-layer coated optical fiber is shown in a schematic cross-sectional view in FIG. 1. The coated optical fiber 10 includes a glass fiber 11 surrounded by three coating layers, namely, a first high-modulus coating 14, a low-modulus coating 16, and a second high-modulus coating 18. In some embodiments the first and second high-modulus coatings 14, 18 may have the same compositions and Young's modulus. In other embodiments, the first and second high-modulus coatings 14, 18 may have different compositions and Young's modulus. In another embodiment, the first high-modulus coating 14, the low-modulus coating 16, and/or the second high-modulus coating 18 may have an adhesion promoter. In some embodiments, the second high-modulus coating 18 may include a pigment. Additionally, one or more pigmented outer coating layers may surround the second high-modulus coating 18. The first high-modulus coating 14, the second high-modulus coating 18, and the low-modulus coating 16 may generally be referred to as a coating of the glass fiber 11. The first high-modulus coating 14 may be referred to as a first coating layer or as a first high-modulus coating layer. The low-modulus coating 16 may be referred to as a second coating layer or as a low-modulus coating layer. The second high-modulus coating 18 may be referred to as a third coating layer or as a second high-modulus coating layer. Further description of the first and second high-modulus coatings 14, 18, and of the low-modulus coating 16 is discussed below.

The glass fiber 11 is an uncoated optical fiber including a core 12 and a cladding 13. The core 12 has a higher refractive index than cladding 13 and glass fiber 11 functions as a waveguide. In many applications, the core 12 and cladding 13 have a discernible core-cladding boundary. Alternatively, the core 12 and cladding 13 can lack a distinct boundary. One such fiber is a step-index fiber. Another such fiber is a graded-index fiber, which has a core whose refractive index varies with distance from the fiber center. A graded-index fiber is formed basically by diffusing the glass core and cladding layer into one another. The cladding 13 can include one or more layers. The one or more cladding layers can include an inner cladding layer that surrounds the core 12 and an outer cladding layer that surrounds the inner cladding layer. The inner cladding layer and outer cladding layer differ in refractive index. For example, the inner cladding layer may have a lower refractive index than the outer cladding layer. A depressed index layer may also be positioned between the inner cladding layer and outer cladding layer.

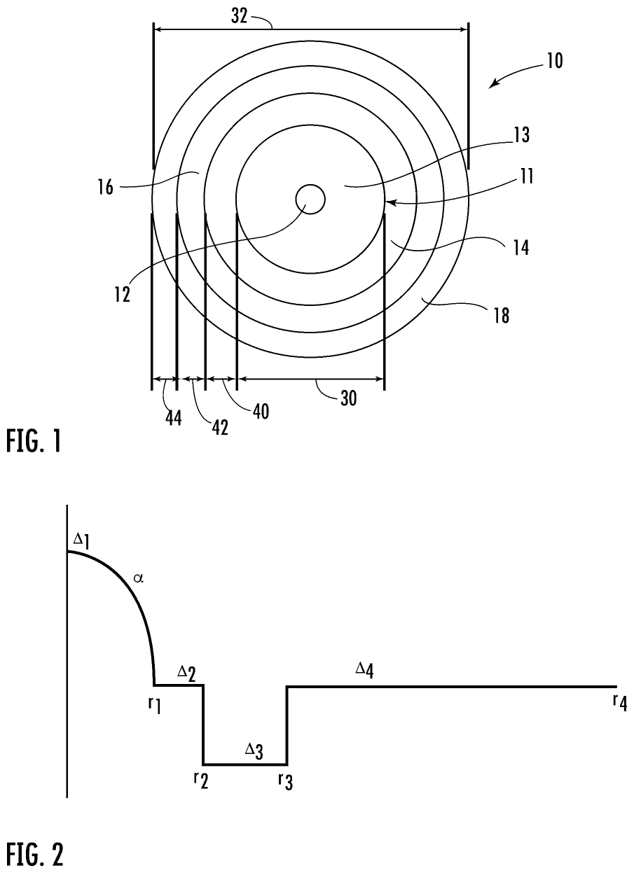

The optical fiber 10 may also be single or multi-mode at the wavelength of interest (e.g., 1310 nm or 1550 nm). The optical fiber 10 may be adapted for use as a data transmission fiber (e.g., SMF-28®, LEAF®, and METROCOR®, each of which is available from Corning Incorporated of Corning, N.Y.). Alternatively, the optical fiber 10 may perform an amplification, dispersion compensation, or polarization maintenance function. The skilled artisan will appreciate that the coatings described herein are suitable for use with virtually any optical fiber for which protection from the environment is desired. For example, FIG. 2 illustrates schematically a generic profile design for a single mode fiber (SMF). The fiber consists of a core, an inner cladding, a low index trench, and an outer cladding. The core can be a step index profile with α>5, or can be a graded index profile. The core can be doped with for example, germanium (e.g., GeO₂), phosphorus (e.g., P₂O₅), aluminum (e.g. Al₂O₃), chlorine, or an alkali metal oxide (e.g. Na₂O, K₂O, Li₂O, Cs₂O, or Rb₂O). The core delta (Δ₁) is between about 0.15% to about 0.50%, or about 0.20% to about 0.45%, or about 0.30% to about 0.40%. Although not depicted in FIG. 2, in some embodiments, the relative refractive index of the core has a centerline dip such that the maximum refractive index of the core is located a small distance away from the centerline of the core, rather than at the centerline as depicted in FIG. 2. The core radius r₁ is between about 3 μm to about 6 μm. The inner cladding may be comprised of un-doped silica glass and has a delta (Δ₂) between about −0.20% to about 0.20%, or about −0.15% to about 0.15%, or about −0.10% to about 0.10%, or about 0.00%. The outer radius r2 of the inner cladding is between about 6 μm to about 14 μm. In some embodiments, the optical fibers disclosed herein do not comprise the inner cladding so that the low index trench is positioned directly adjacent to the core. The low index trench comprises down-doped silica glass. In embodiments, the low index trench is doped with fluorine or boron. The low index trench has a delta (Δ₃) between about −0.20% to about −0.70%, or about −0.25% to about −0.60%, or about −0.30% to about −0.55%. The width of the trench is between about 3 μm to 8 μm so that the outer radius r3 is 9 μm to about 22 μm. The outer cladding can be pure silica glass, or silica glass doped with up-dopant such as chlorine or germanium to increase the index, or a down-dopant such as fluorine to decrease the index. The outer cladding may have a delta (Δ₄) between about −0.20% to about 0.20%, or about −0.15% to about 0.15%, or about −0.10% to about 0.10%, or about 0.00%. In some embodiments, the delta of the outer cladding (Δ₄) is equal to or substantially equal to the delta of the inner cladding (Δ₂). The outer radius r4 of the outer cladding is between about 50 μm to about 62.5 μm. The optical fiber 10 is not limited to a single mode fiber and other profile designs can be used with the three-layer coating.

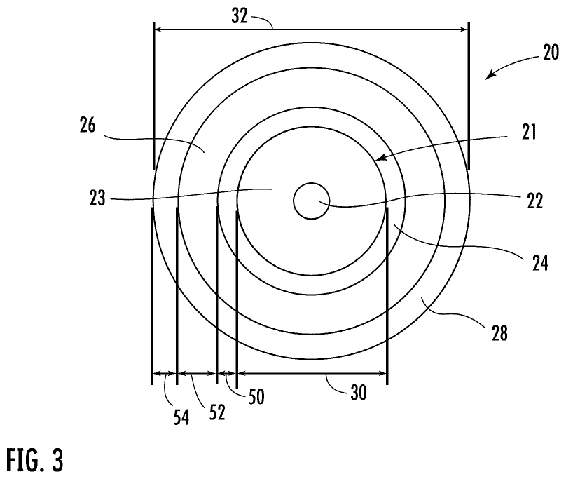

Referring now to FIG. 3, an optical fiber 20 according to a second embodiment includes a glass fiber 21 surrounded by three coating layers, namely, a low-modulus coating 24, a first high-modulus coating 26, and a second high-modulus coating 28. The glass fiber 21 is an uncoated optical fiber including a core 22 and a cladding 23 and can generally be of the same types described above with respect to the glass fiber 11 of FIG. 1. In some embodiments, the first and second high-modulus coatings 26, 28 may have the same Young's modulus coatings. In other embodiments, the first and second high-modulus coatings 26, 28 may have different Young's modulus. For example, the first and second high-modulus coatings 26, 28 may have different Young's modulus, where the second high-modulus coatings 28 has a higher Young's modulus than the first high-modulus coating 26. In some embodiments, the first and second high-modulus coatings 26, 28 have different compositions. In another embodiment, the low-modulus coating 24, the first high-modulus coating 26, and/or the second high-modulus coating 28 may have an adhesion promoter. In some embodiments, the second high-modulus coating 28 may include a pigment. Additionally, one or more pigmented outer coating layers may surround the second high-modulus coating 28. The first high-modulus coating 26, the second high-modulus coating 28, and the low-modulus coating 24 may generally be referred to as a coating of the glass fiber 21. The low-modulus coating 24 may be referred to as a first coating layer or as a low-modulus coating layer. The first high-modulus coating 26 may be referred to as a second coating layer or as a first high-modulus coating layer. The second high-modulus coating 28 may be referred to as a third coating layer or as a second high-modulus coating layer. Further description of the first and second high-modulus coatings 26, 28, and of the low-modulus coating 24 is discussed below.

Referring to both FIGS. 1 and 3, an outer circumference of the glass fiber 11, 21 may have a diameter 30 of at least 100 μm, or less than 125 μm, or between about 100 μm and about 125 μm. In various embodiments, the diameter 30 of the glass fiber 11, 21 is about 100 μm, about 102.5 μm, about 105 μm, about 108 μm, about 110 μm, about 111 μm, about 113 μm, about 116 μm, about 118 μm, about 119 μm, about 120 μm, about 121.5 μm, about 123 μm, about 124 μm, about 125 μm, or about 126 μm, or within any range bound by any two of those values (e.g., from 100 μm to 126 μm, from 102.5 μm to 118 μm, from 105 μm to 113 μm, and so on).

It is noted that an outer diameter of the cladding 13, 23 is the diameter of the glass fiber 11, 21 and that an outer diameter of the second high-modulus coating 18, 28 may be an outer diameter 32 of an outer circumference of the optical fiber 10, 20 (when a pigmented outer coating layer is not applied). The optical fiber 10, 20 may have an outer diameter 32 between about 150 μm and about 200 μm, or at least about 150 μm, or at least about 175 μm, or at least about 200 μm. In embodiments, the outer diameter 32 of the outer circumference of the optical fiber 10, 20 is less than about 200 μm, or less than about 190 μm, or less than about 180 μm, or less than about 175 μm, or less about 170 μm, or less than about 165 μm, or between about 150 μm and about 190 μm, or between about 155 μm and about 180 μm, or between about 160 μm and about 170 μm, or between about 160 and about 168 μm. In specific examples, the outer diameter 32 of the outer circumference of the optical fiber 10, 20 is about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, or about 210 μm, or within any range bound by any two of those values (e.g., from 135 μm to 210 μm, from 145 μm to 185 μm, from 175 μm to 200 μm, and so on).

Continuing to refer to FIGS. 1 and 3, the low-modulus coating 16, 24 may have a Young's modulus at 25° C. of less than about 5 MPa, or less than about 3 MPa, or less than about 1 MPa, or between about 0.20 MPa and about 5 MPa, or between about 0.65 MPa and about 5 MPa, or between about 0.20 MPa and about 3 MPa, or between about 0.65 MPa and about 3 MPa, or between about 0.20 MPa and about 1 MPa, or between about 0.65 MPa and about 1 MPa. In various examples, the Young's modulus of the low modulus coating 16, 24 is about 0.25 MPa, about 0.50 MPa, about 0.65 MPa, about 0.80 MPa, about 1 MPa, about 1.25 MPa, about 1.5 MPa, about 1.75 MPa, about 2 MPa, about 2.25 MPa, about 2.5 MPa, about 2.85 MPa, about 3 MPa, about 3.35 MPa, about 3.65 MPa, about 4 MPa, about 4.25 MPa, about 4.5 MPa, about 4.75 MPa or about 5 MPa, or within any range bound by any two of those values (e.g., from about 0.25 MPa to about 5 MPa, from about 0.65 MPa to about 3 MPa, from about 3 MPa to about 5 MPa, and so on).

The first high-modulus coating 14, 26 may have a Young's modulus at 25° C. of at least about 500 MPa, or at least about 1200 MPa, or at least about 1700 MPa, or at least about 2100 MPa, or at least about 2700 MPa, or at least about 3100 MPa, or at least about 3300 MPa, or at least about 4000 MPa or between about 500 MPa and about 3500 MPa, or between about 1000 MPa and about 3000 MPa, or between about 1800 MPa and about 3200 MPa. In various examples, the Young's modulus of the first high-modulus coating 14, 26 is about 500 MPa, about 750 MPa, about 900 MPa, about 1000 MPa, about 1400 MPa, about 1800 MPa, about 2000 MPa, about 2250 MPa, about 2500 MPa, about 2750 MPa, about 3000 MPa, about 3300 MPa, about 3600 MPa, about 3900 MPa, about 4000 MPa, about 4500 MPa, or about 5000 MPa, or within any range bound by any two of those values (e.g., from about 500 MPa to about 5000 MPa, from about 1400 MPa to about 3900 MPa, from about 2000 MPa to about 3300 MPa, and so on).

The second high-modulus coating 18, 28 may have a Young's modulus at 25° C. of at least about 500 MPa, or at least about 1200 MPa, or at least about 1700 MPa, or at least about 2100 MPa, or at least about 2700 MPa, or at least about 3100 MPa, or at least about 3300 MPa, or at least about 4000 MPa, or between about 500 MPa and about 3500 MPa, or between about 1000 MPa and about 3000 MPa, or between about 1800 MPa and about 3200 MPa. In various examples, the Young's modulus of the second high-modulus coating 18, 28 is about 500 MPa, about 750 MPa, about 900 MPa, about 1000 MPa, about 1400 MPa, about 1800 MPa, about 2000 MPa, about 2250 MPa, about 2500 MPa, about 2750 MPa, about 3000 MPa, about 3300 MPa, about 3600 MPa, about 3900 MPa, about 4000 MPa, about 4500 MPa, or about 5000 MPa, or within any range bound by any two of those values (e.g., from about 500 MPa to about 5000 MPa, from about 1400 MPa to about 3900 MPa, from about 2000 MPa to about 3300 MPa, and so on).

Referring to FIG. 1, the first high-modulus coating 14 may have a thickness 40 of less than about 16.5 μm, or less than about 16 μm, or less than about 15 μm, or less than about 12 μm, or less than about 10 μm, or less than about 9 μm, or less than about 5 μm, or between about 0.5 μm and about 16 μm, or between about 1 μm and about 15 μm, or between about 5 μm and about 13 μm, or between about 8 μm and about 12 μm. In various specific examples, the thickness 40 of the first high-modulus coating 14 is about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, about 12 μm, about 12.5 μm, about 13 μm, about 13.5 μm, about 14 μm, about 14.5 μm, about 15 μm, about 15.5 μm, about 16 μm, or about 16.5 μm, or within any range bound by any two of those values (e.g., from about 2.5 μm to about 16.5 μm, from about 6 μm to about 13.5 μm, from about 8 μm to about 10 μm, and so on).

The low-modulus coating 16 may have a thickness 42 of less than about 22 μm, or less than about 20 μm, or less than about 17.5 μm, or less than about 15 μm, or less than about 12 μm, or less than about 8 μm, or less than about 5 μm, or between about 4 μm and about 22 μm, or between about 6 μm and about 19 μm, or between about 10 μm and about 17.5 μm. In various specific examples, the thickness 42 of the low-modulus coating 16 is about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, about 12 μm, about 12.5 μm, about 13 μm, about 13.5 μm, about 14 μm, about 14.5 μm, about 15 μm, about 15.5 μm, about 16 μm, about 16.5 μm, about 17 μm, about 17.5 μm, about 18 μm, about 18.5 μm, about 19 μm, about 19.5 μm, about 20 μm, about 20.5 μm, about 21.5 μm, or about 22 μm, or within any range bound by any two of those values (e.g., from about 3 μm to about 22 μm, from about 6.5 μm to about 20 μm, from about 12.5 μm to about 17 μm, and so on).

The second high-modulus coating 18 may have a thickness 44 of less than about 28 μm, or less than about 25 μm, or less than about 20 μm, or less than about 15 μm, or less than about 10 μm, or less than about 7 μm, or between about 6 μm and about 28 μm, or between about 12 and about 25 μm, or between about 10 μm and about 15 μm. In various specific examples, the thickness 44 of the second high-modulus coating 18 is about 3 μm, about 4 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, about 12 μm, about 12.5 μm, about 13 μm, about 13.5 μm, about 14 μm, about 14.5 μm, about 15 μm, about 15.5 μm, about 16 μm, about 16.5 μm, about 17 μm, about 17.5 μm, about 18 μm, about 18.5 μm, about 19 μm, about 19.5 μm, about 20 μm, about 20.5 μm, about 21.5 μm, about 22 μm, about 22.5 μm, about 23 μm, about 23.5 μm, about 24 μm, about 24.5 μm, about 25 μm, or about 26 μm, or within any range bound by any two of those values (e.g., from about 3 μm to about 26 μm, from about 6.5 μm to about 25 μm, from about 12.5 μm to about 17 μm, and so on).

Referring to FIG. 3, the low-modulus coating 24 may have a thickness 50 of less than about 16.5 μm, or less than about 16 μm, or less than about 15 μm, or less than about or less than about 12 μm, or less than about 10 μm, or less than about 9 μm, or less than about 5 μm, or between about 4 μm and about 16 μm, or between about 8 μm and about 14 μm, or between about 10 μm and about 15 μm. In various specific examples, the thickness 50 of the low-modulus coating 24 is about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, about 12 μm, about 12.5 μm, about 13 μm, about 13.5 μm, about 14 μm, about 14.5 μm, about 15 μm, about 15.5 μm, about 16 μm, or about 16.5 μm, or within any range bound by any two of those values (e.g., from about 2.5 μm to about 16.5 μm, from about 6 μm to about 13.5 μm, from about 8 μm to about 10 μm, and so on).

The first high-modulus coating 26 may have a thickness 52 of less than about 21 μm, or less than about 20 μm, or less than about 16 μm, or less than about 12 μm, or less than about 9 μm, or less than about 5.5 μm, or between about 3 μm and about 21 μm, or between about 5 μm and about 15 μm, or between about 8 and about 12 μm. In various specific examples, the thickness 52 of the first high-modulus coating 26 is about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, about 12 μm, about 12.5 μm, about 13 μm, about 13.5 μm, about 14 μm, about 14.5 μm, about 15 μm, about 15.5 μm, about 16 μm, about 16.5 μm, about 17 μm, about 17.5 μm, about 18 μm, about 18.5 μm, about 19 μm, about 19.5 μm, about 20 μm, about 20.5 μm, or about 21 μm, or within any range bound by any two of those values (e.g., from about 3 μm to about 21 μm, from about 6.5 μm to about 18 μm, from about 12.5 μm to about 17 μm, and so on).

The second high-modulus coating 28 may have a thickness 54 of less than about 26 μm, or less than about 25 μm, or less than about 20 μm, or less than about 15 μm, or less than about 10 μm, or less than about 7 μm, or between about 6 μm and about 28 μm, or between about 12 and about 25 μm, or between about 10 μm and about 15 μm. In various specific examples, the thickness 54 of the second high-modulus coating 28 is about 3 μm, about 4 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 10.5 μm, about 11 μm, about 11.5 μm, about 12 μm, about 12.5 μm, about 13 μm, about 13.5 μm, about 14 μm, about 14.5 μm, about 15 μm, about 15.5 μm, about 16 μm, about 16.5 μm, about 17 μm, about 17.5 μm, about 18 μm, about 18.5 μm, about 19 μm, about 19.5 μm, about 20 μm, about 20.5 μm, about 21.5 μm, about 22 μm, about 22.5 μm, about 23 μm, about 23.5 μm, about 24 μm, about 24.5 μm, about 25 μm, or about 26 μm, or within any range bound by any two of those values (e.g., from about 3 μm to about 26 μm, from about 6.5 μm to about 25 μm, from about 12.5 μm to about 17 μm, and so on).

At least one of the first high-modulus coating layer 14, 26, the second high-modulus coating layer 18, 28, and the low-modulus coating layer 16, 24 is a radially innermost coating layer that is directly adjacent the glass cladding 13, 23, the radially innermost coating layer being the thinnest coating layer. Therefore, for example with reference to the embodiment of FIG. 1, in embodiments, first high-modulus coating 14 is the radially innermost coating layer and is thinner than either of second high-modulus coating 18 and low-modulus coating 16. As another example with reference to FIG. 3, in embodiments, low-modulus coating 24 is the radially innermost coating layer and is thinner than either of first-high modulus coating 26 and second high-modulus coating 28.

Low-Modulus Coating Compositions. The low-modulus coatings 16, 24 are a cured product of a curable low-modulus coating composition. The curable low-modulus coating compositions provide a low-modulus coating for optical fibers that exhibits low Young's modulus, low pullout force, and strong cohesion. The low-modulus coating is a cured product of a radiation-curable low-modulus coating composition that includes an oligomer, a monomer, a photoinitiator and, optionally, an additive. The following disclosure describes oligomers for the radiation-curable low-modulus coating compositions, radiation-curable low-modulus coating compositions containing at least one of the oligomers, cured products of the radiation-curable low-modulus coating compositions that include at least one of the oligomers, glass fibers or first high-modulus coatings coated with a radiation-curable low-modulus coating composition containing at least one of the oligomers, and glass fibers or first high-modulus coatings coated with the cured product of a radiation-curable low-modulus coating composition containing at least one of the oligomers.

The oligomer may include a polyether urethane diacrylate compound or a combination of a polyether urethane diacrylate compound and a di-adduct compound. In one embodiment, the polyether urethane diacrylate compound has a linear molecular structure. In one embodiment, the oligomer is formed from a reaction between a diisocyanate compound, a polyol compound, and a hydroxy acrylate compound, where the reaction produces a polyether urethane diacrylate compound as a primary product (majority product) and a di-adduct compound as a byproduct (minority product). The reaction forms a urethane linkage upon reaction of an isocyanate group of the diisocyanate compound and an alcohol group of the polyol. The hydroxy acrylate compound reacts to quench residual isocyanate groups that are present in the composition formed from reaction of the diisocyanate compound and polyol compound. As used herein, the term “quench” refers to conversion of isocyanate groups through a chemical reaction with hydroxyl groups of the hydroxy acrylate compound. Quenching of residual isocyanate groups with a hydroxy acrylate compound converts terminal isocyanate groups to terminal acrylate groups.

The diisocyanate compound, hydroxy acrylate compound and polyol are combined simultaneously and reacted, or are combined sequentially (in any order) and reacted. In one embodiment, the oligomer is formed by reacting a diisocyanate compound with a hydroxy acrylate compound and reacting the resulting product composition with a polyol. In another embodiment, the oligomer is formed by reacting a diisocyanate compound with a polyol compound and reacting the resulting product composition with a hydroxy acrylate compound.

The oligomer may be formed from a reaction of a diisocyanate compound, a hydroxy acrylate compound, and a polyol, where the molar ratio of the diisocyanate compound to the hydroxy acrylate compound to the polyol in the reaction process is n:m:p. n, m, and p are referred to herein as mole numbers or molar proportions of diisocyanate, hydroxy acrylate, and polyol; respectively. The mole numbers n, m and p are positive integer or positive non-integer numbers. In embodiments, when p is 2.0, n is in the range from 3.0 to 5.0, or in the range from 3.2 to 4.8, or in the range from 3.4 to 4.6, or in the range from 3.5 to 4.4, or in the range from 3.6 to 4.2, or in the range from 3.7 to 4.0; and m is in the range from 1.5 to 4.0, or in the range from 1.6 to 3.6, or in the range from 1.7 to 3.2, or in the range from 1.8 to 2.8, or in the range from 1.9 to 2.4. For values of p other than 2.0, the molar ratio n:m:p scales proportionally. For example, the molar ratio n:m:p=4.0:3.0:2.0 is equivalent to the molar ratio n:m:p=2.0:1.5:1.0.

The curable low-modulus coating composition further includes one or more monomers. The one or more monomers is/are selected to be compatible with the oligomer, to control the viscosity of the low-modulus coating composition to facilitate processing, and/or to influence the physical or chemical properties of the coating formed as the cured product of the low-modulus coating composition. The monomers may include radiation-curable monomers such as ethylenically-unsaturated compounds, ethoxylated acrylates, ethoxylated alkylphenol monoacrylates, propylene oxide acrylates, n-propylene oxide acrylates, isopropylene oxide acrylates, monofunctional acrylates, monofunctional aliphatic epoxy acrylates, multifunctional acrylates, multifunctional aliphatic epoxy acrylates, and combinations thereof.

Representative radiation-curable ethylenically unsaturated monomers may include alkoxylated monomers with one or more acrylate or methacrylate groups. An alkoxylated monomer is one that includes one or more alkoxylene groups, where an alkoxylene group has the form —O—R— and R is a linear or branched alkylene group. Examples of alkoxylene groups include ethoxylene (—O—CH₂—CH₂—), n-propoxylene (—O—CH₂—CH₂—CH₂—), isopropoxylene (—O—CH₂—CH(CH₃)—, or —O—CH(CH₃)—CH₂—), etc. As used herein, the degree of alkoxylation refers to the number of alkoxylene groups in the monomer. In one embodiment, the alkoxylene groups are bonded consecutively in the monomer.

In some embodiments, the low-modulus coating composition includes an alkoxylated monomer of the form R4-R5-O—(CH(CH₃) CH₂—O)q-C(O)CH═CH₂, where R4 and R5 are aliphatic, aromatic, or a mixture of both, and q=1 to 10, or R4-O—(CH(CH₃)CH₂—O)q-C(O)CH═CH₂, where C(O) is a carbonyl group, R1 is aliphatic or aromatic, and q=1 to 10.

In some embodiments, the monomer component of the low-modulus coating composition includes a multifunctional (meth)acrylate. Multifunctional ethylenically unsaturated monomers include multifunctional acrylate monomers and multifunctional methacrylate monomers. Multifunctional acrylates are acrylates having two or more polymerizable acrylate moieties per molecule, or three or more polymerizable acrylate moieties per molecule.

In some embodiments, the low-modulus coating composition includes an N-vinyl amide monomer such as an N-vinyl lactam, or N-vinyl pyrrolidinone, or N-vinyl caprolactam.

In addition to a curable monomer and a curable oligomer, the curable low-modulus coating composition also includes a polymerization initiator. The polymerization initiator facilitates initiation of the polymerization process associated with the curing of the coating composition to form the coating. Polymerization initiators include thermal initiators, chemical initiators, electron beam initiators, and photoinitiators. Photoinitiators include ketonic photoinitiators and/or phosphine oxide photoinitiators. When used in the curing of the coating composition, the photoinitiator is present in an amount sufficient to enable rapid radiation curing.

The curable low-modulus coating composition optionally includes one or more additives. Additives include an adhesion promoter, a strength additive, an antioxidant, a catalyst, a stabilizer, an optical brightener, a property-enhancing additive, an amine synergist, a wax, a lubricant, and/or a slip agent. Some additives operate to control the polymerization process, thereby affecting the physical properties (e.g., modulus, glass transition temperature) of the polymerization product formed from the coating composition. Other additives affect the integrity of the cured product of the low-modulus coating composition (e.g., protect against de-polymerization or oxidative degradation).

High Modulus Coating—Compositions. The first high-modulus coating 14, 26 and the second high-modulus coating 18, 28, generally referred to as high-modulus coatings, are a cured product of a curable high-modulus coating composition that includes a monomer, a photoinitiator, an optional oligomer, and an optional additive. The present disclosure describes optional oligomers for the radiation-curable high-modulus coating compositions, radiation-curable high-modulus coating compositions, cured products of the radiation-curable high-modulus coating compositions, optical fibers coated with a radiation-curable high-modulus coating composition, and optical fibers coated with the cured product of a radiation-curable high-modulus coating composition.

The high-modulus coating is formed as the cured product of a radiation-curable high-modulus coating composition that includes a monomer component with one or more monomers. The monomers preferably include ethylenically unsaturated compounds. In one embodiment, the high-modulus coating is the radiation-cured product of a high-modulus coating composition that contains urethane acrylate monomers.

The monomers include functional groups that are polymerizable groups and/or groups that facilitate or enable crosslinking. The monomers are monofunctional monomers or multifunctional monomers. In combinations of two or more monomers, the constituent monomers are monofunctional monomers, multifunctional monomers, or a combination of monofunctional monomers and multifunctional monomers. In one embodiment, the monomer component of the curable high-modulus coating composition includes ethylenically unsaturated monomers. Suitable functional groups for ethylenically unsaturated monomers include, without limitation, (meth)acrylates, acrylamides, N-vinyl amides, styrenes, vinyl ethers, vinyl esters, acid esters, and combinations thereof.

In one embodiment, the monomer component of the curable high-modulus coating composition includes ethylenically unsaturated monomers. The monomers include functional groups that are polymerizable groups and/or groups that facilitate or enable crosslinking. The monomers are monofunctional monomers or multifunctional monomers. In combinations of two or more monomers, the constituent monomers are monofunctional monomers, multifunctional monomers, or a combination of monofunctional monomers and multifunctional monomers. Suitable functional groups for ethylenically unsaturated monomers include, without limitation, (meth)acrylates, acrylamides, N-vinyl amides, styrenes, vinyl ethers, vinyl esters, acid esters, and combinations thereof.

Representative radiation-curable ethylenically unsaturated monomers included alkoxylated monomers with one or more acrylate or methacrylate groups. An alkoxylated monomer is one that includes one or more alkoxylene groups, where an alkoxylene group has the form —O—R— and R is a linear or branched hydrocarbon. Examples of alkoxylene groups include ethoxylene (—O—CH₂—CH₂—), n-propoxylene (—O—CH₂—CH₂—CH₂—), isopropoxylene (—O—CH₂—CH(CH₃)—), etc. As used herein, the degree of alkoxylation refers to the number of alkoxylene groups in the monomer. In one embodiment, the alkoxylene groups are bonded consecutively in the monomer.

Multifunctional ethylenically unsaturated monomers for the curable high-modulus coating composition include, without limitation, alkoxylated bisphenol A diacrylates, such as ethoxylated bisphenol A diacrylate, with the degree of alkoxylation being 2 or greater. The monomer component of the high-modulus coating composition may include ethoxylated bisphenol A diacrylate with a degree of ethoxylation ranging from 2 to about 30 or propoxylated bisphenol A diacrylate with the degree of propoxylation being 2 or greater; for example, ranging from 2 to about 30; methylolpropane polyacrylates with and without alkoxylation such as ethoxylated trimethylolpropane triacrylate with the degree of ethoxylation being 3 or greater.

The curable high-modulus coating composition also includes a photoinitiator and optionally includes additives such as anti-oxidant(s), optical brightener(s), amine synergist(s), tackifier(s), catalyst(s), a carrier or surfactant, and a stabilizer as described above in connection with the curable low-modulus coating composition.

Adhesion Promoters. An adhesion promoter enhances the adhesion of the coating to the underlying glass fiber. Any suitable adhesion promoter can be employed. Examples of a suitable adhesion promoter include, without limitation, organofunctional silanes, titanates, zirconates, and mixtures thereof. One class of suitable adhesion promoters are the poly(alkoxy) silanes. Suitable alternative adhesion promoters include, without limitation, bis(trimethoxysilylethyl)benzene, 3-mercaptopropyltrimethoxysilane (3-MPTMS, available from United Chemical Technologies, Bristol, Pa.; also available from Gelest, Morrisville, Pa.), 3-acryloxypropyltrimethoxysilane (available from Gelest), and 3-methacryloxypropyltrimethoxysilane (available from Gelest), and bis(trimethoxysilylethyl)benzene (available from Gelest). Other suitable adhesion promoters are described in U.S. Pat. Nos. 4,921,880 and 5,188,864 to Lee et al., each of which is hereby incorporated by reference. The adhesion promoter, if present, may be used in an amount between about 0.1 pph to about 10 pph (parts per hundred), or about 0.25 pph to about 3 pph, or about 0.3 pph to about 5 pph. In various embodiments, the adhesion promoter is present in an amount of about 0.1 pph, 0.2 pph, 0.25 pph, 0.3 pph, 0.4 pph, 0.5 pph, 0.75 pph, 1 pph, 1.5 pph, 2 pph, 2.5 pph, 3 pph, 4 pph, 5 pph, 6 pph, 7 pph, 8 pph, 9 pph, 10 pph, or 11 pph, or within any range bound by any two of those values (e.g., from 0.1 pph to 1 pph, from 0.75 pph to 7 pph, from 2.5 pph to 5 pph, and so on).

Exemplary high-modulus and low-modulus coatings are discussed below.

High-Modulus Coating—Compositions. Four exemplary curable high-modulus coating compositions (A, B, C, and D) are listed in Table 1.

TABLE 1
High-Modulus Coating Compositions

High-Modulus Coating Compositions

| Component | A | B | C | D |
|---|---|---|---|---|
| PE210 (wt %) | 15.0 | 15.0 | 15.0 | 15.0 |
| M240 (wt %) | 72.0 | 72.0 | 72.0 | 62.0 |
| M2300 (wt %) | 10.0 | — | — | — |
| M3130 (wt %) | — | 10.0 | — | — |
| M370 (wt %) | — | — | 10.0 | 20.0 |
| TPO (wt %) | 1.5 | 1.5 | 1.5 | 1.5 |
| Irgacure 184 (wt %) | 1.5 | 1.5 | 1.5 | 1.5 |
| Irganox 1035 (pph) | 0.5 | 0.5 | 0.5 | 0.5 |
| DC-190 (pph) | 1.0 | 1.0 | 1.0 | 1.0 |

PE210 is bisphenol-A epoxy diacrylate (currently available from Miwon Specialty Chemical, Korea), M240 is ethoxylated (4) bisphenol-A diacrylate (currently available from Miwon Specialty Chemical, Korea), M2300 is ethoxylated (30) bisphenol-A diacrylate (currently available from Miwon Specialty Chemical, Korea), M3130 is ethoxylated (3) trimethylolpropane triacrylate (currently available from Miwon Specialty Chemical, Korea), M370 is Tris(2-hydroxy ethyl) isocyanurate triacrylate (currently available from Miwon Specialty Chemical, Korea), TPO (a photoinitiator) is (2,4,6-trimethylbenzoyl)diphenyl phosphine oxide (currently available from BASF), Irgacure 184 (a photoinitiator) is 1-hydroxycyclohexyl-phenyl ketone (currently available from BASF), Irganox 1035 (an antioxidant) is benzenepropanoic acid, 3,5-bis(1,1-dimethylethyl)-4-hydroxythiodi-2,1-ethanediyl ester (currently available from BASF). DC190 (a slip agent) is silicone-ethylene oxide/propylene oxide copolymer (currently available from Dow Chemical). The concentration unit “pph” refers to an amount relative to a base composition that includes all monomers and photoinitiators. For example, for high-modulus coating composition A, a concentration of 1.0 pph for DC-190 corresponds to 1 g DC-190 per 100 g combined of PE210, M240, M2300, TPO, and Irgacure 184.

A fifth exemplary high-modulus coating composition, a curable acrylate resin, is shown in Table 2.

TABLE 2
High-Modulus Coating Composition

| | High-Modulus Coating | |
|---|---|---|
| | Composition | |
| Component | E | |
| Diurethane Dimethacrylate Isomers | 20-50 | wt % |
| Pentaerythritol Triacrylate | 5-10 | wt % |
| Trimethylolpropane Triacrylate | 20-50 | wt % |
| Naphtha (petroleum) Heavy Alkylate | 0.2-1.0 | wt % |
| Irgacure/Darocure 1173 | 5-15 | wt % |

Diurethane Dimethacrylate Isomers is 7,7,9-Trimethyl-4,13-dioxo-dioxa5,12-diza-hexadecan-1,16-diol dimethacrylate (currently available from Sigma Aldrich). Pentaerythritol Triacrylate is currently available from Sigma Aldrich. Trimethylolpropane Triacrylate is 2-propenoic acid 2-ethyl-2-[[(1-oxo-2-propenyl)oxy]methyl]-1,3-propanediyl ester (currently available from Sigma Aldrich). Naphtha (petroleum) Heavy Alkylate is a coating additive (currently available from BOC Sciences). Irgacure/Darocure 1173 is 2-hydroxy-2-methyl-1-phenyl-1-propanone and a photoinitiator (currently available from BASF).

High-Modulus Coatings—Tensile Properties. The Young's modulus, tensile strength at yield, yield strength, and elongation at yield of high-modulus coatings made from high-modulus compositions A, B, C, D, and E are shown in Table 3. The curable high-modulus coating compositions were cured and configured in the form of cured rod samples for measurement of Young's modulus, tensile strength at yield, yield strength, and elongation at yield. The cured rods were prepared by injecting the curable high-modulus coating composition into Teflon® tubing having an inner diameter of about 0.025″. The rod samples were cured using a Fusion D bulb at a dose of about 2.4 J/cm² (measured over a wavelength range of 225-424 nm by a Light Bug model IL390 from International Light). After curing, the Teflon® tubing was stripped away to provide a cured rod sample of the high-modulus coating composition. The cured rods were allowed to condition for 18-24 hours at 23° C. and 50% relative humidity before testing. Young's modulus, tensile strength at break, yield strength, and elongation at yield were measured using a Instron 5943 Tensile Tester on defect-free rod samples with a gauge length of 51 mm, and a test speed of 250 mm/min. Tensile properties of the cured rod were measured according to ASTM Standard D638 and ASTM Standard D882. The properties were determined as an average of at least five samples, with defective samples being excluded from the average.

TABLE 3
Tensile Properties of High-modulus Coatings

| | High-Modulus Coating Compositions | | | | |
|---|---|---|---|---|---|
| | A | B | C | D | E |
| Young's | 1929 ± 25 | 2531.89 | 2652.51 | 2775.94 | 3101 ± 119 |
| Modulus (MPa) | | | | | |
| Tensile | 64.2 ± 5 | 75.56 | 82.02 | 86.08 | 101.8 ± 13.7 |
| Strength | | | | | |
| (MPa) | | | | | |
| Yield | 48.21 | 61.23 | 66.37 | 70.05 | — |
| Strength | | | | | |
| (MPa) | | | | | |
| Elongation at | 31.8 ± 3 | 4.53 | 4.76 | 4.87 | 4.9 ± 1.1 |
| Yield (%) | | | | | |

Low-Modulus Coating—Composition. The exemplary low-modulus coating composition includes the formulation given in Table 4 below.

TABLE 4
Reference Low-modulus Coating Composition
Low-modulus Coating Composition

| | |
|---|---|
| Component | Amount |

| | | |
|---|---|---|
| Oligomeric Material | 50.0 | wt % |
| SR504 | 46.5 | wt % |
| NVC | 2.0 | wt % |
| TPO | 1.5 | wt % |
| Irganox 1035 | 1.0 | pph |
| 3-Acryloxypropyl trimethoxysilane | 0.8 | pph |
| Pentaerythritol tetrakis(3-mercaptopropionate) | 0.032 | pph |

Where the oligomeric material was prepared as described herein from H12MDI, HEA, and PPG4000 using a molar ratio n:m:p=3.5:3.0:2.0, SR504 is ethoxylated(4)nonylphenol acrylate (available from Sartomer), NVC is N-vinylcaprolactam currently (available from Aldrich), TPO (a photoinitiator) is (2,4,6-trimethylbenzoyl)-diphenyl phosphine oxide (currently available from BASF), Irganox 1035 (an antioxidant) is benzenepropanoic acid, 3,5-bis(1,1-dimethylethyl)-4-hydroxythiodi-2,1-ethanediyl ester (currently available from BASF), 3-acryloxypropyl trimethoxysilane is an adhesion promoter (currently available from Gelest), and pentaerythritol tetrakis(3-mercaptopropionate) (also known as tetrathiol, currently available from Aldrich) is a chain transfer agent. The concentration unit “pph” refers to an amount relative to a base composition that includes all monomers, oligomers, and photoinitiators. For example, a concentration of 1.0 pph for Irganox 1035 corresponds to 1 g Irganox 1035 per 100 g combined of oligomeric material, SR504, NVC, and TPO.

The oligomeric material was prepared by mixing H12MDI (4,4′-methylene bis(cyclohexyl isocyanate)), dibutyltin dilaurate and 2,6-di-tent-butyl-4 methylphenol at room temperature in a 500 mL flask. The 500 mL flask was equipped with a thermometer, a CaCl₂) drying tube, and a stirrer. While continuously stirring the contents of the flask, PPG4000 was added over a time period of 30-40 minutes using an addition funnel. The internal temperature of the reaction mixture was monitored as the PPG4000 was added and the introduction of PPG4000 was controlled to prevent excess heating (arising from the exothermic nature of the reaction). After the PPG4000 was added, the reaction mixture was heated in an oil bath at about 70° C. to 75° C. for about 1 to 1½ hours. At various intervals, samples of the reaction mixture were retrieved for analysis by infrared spectroscopy (FTIR) to monitor the progress of the reaction by determining the concentration of unreacted isocyanate groups. The concentration of unreacted isocyanate groups was assessed based on the intensity of a characteristic isocyanate stretching mode near 2265 cm⁻¹. The flask was removed from the oil bath and its contents were allowed to cool to below 65° C. Addition of supplemental HEA was conducted to insure complete quenching of isocyanate groups. The supplemental HEA was added dropwise over 2-5 minutes using an addition funnel. After addition of the supplemental HEA, the flask was returned to the oil bath and its contents were again heated to about 70° C. to 75° C. for about 1 to 1½ hours. FTIR analysis was conducted on the reaction mixture to assess the presence of isocyanate groups and the process was repeated until enough supplemental HEA was added to fully react any unreacted isocyanate groups. The reaction was deemed complete when no appreciable isocyanate stretching intensity was detected in the FTIR measurement.

Low-Modulus Coatings—Tensile Properties. The Young's modulus, tensile strength at yield, yield strength, and elongation at yield of low-modulus coatings made from the low-modulus composition are shown in Table 5. The curable low-modulus coating composition were cured and configured in the form of cured film samples for measurement of Young's modulus, tensile strength, and elongation at yield. The cured films were prepared by adding low-modulus composition into a casting box with release paper. The film sample is removed from the casting box with the release paper and cured using a Fusion D bulb at a dose of 1.2 J/cm² for at least 20 seconds. The cured films had a thickness of about 8 mil, or about 0.2032 mm. The cured films were allowed to condition for 12-30 hours at 23° C. at 50% relative humidity before being prepared for testing. The film is cut into defect free strips having a width of about 26 mm and a length of about 12.5 cm. Young's modulus, tensile strength, and elongation at yield were measured using a Instron 5943 Tensile Tester with a 50 N load cell and a rubber face gripping pad and a serrated gripping pad on the upper and lower gripping mechanisms on a defect free strip coated with talc. A test speed of 254 mm/min was used. Tensile properties were measured according to ASTM Standard D882-97. The properties were determined as an average of at least five samples, with defective samples being excluded from the average.

TABLE 5
Tensile Properties of the Low-modulus Coating

| | Low-modulus Coating |
|---|---|
| | Composition (LMC) |
| Young's Modulus (MPa) | 0.81 ± 0.04 |
| Tensile Strength (MPa) | 0.7 ± 0.1 |
| Elongation at Yield (%) | 158 ± 19 |

Puncture Resistance Tests. Puncture Resistance of a Coated Optical Fiber with Two-Layered Coating (“Traditional Puncture Resistance Test”). Puncture resistance measurements can be made on traditional optical fibers that include a glass fiber and an inner primary coating, low-modulus coating, surrounded by an outer secondary coating, a high-modulus coating.

The puncture resistance of the traditional optical fibers with the two-layered coating can be measured using the technique described in the article entitled “Quantifying the Puncture Resistance of Optical Fiber Coatings”, by G. Scott Glaesemann and Donald A. Clark, published in the Proceedings of the 52nd International Wire & Cable Symposium, pp. 237-245 (2003), which is incorporated by reference herein. A summary of the method is provided here. The method is an indentation method. A 4-centimeter length of optical fiber is placed on a 3 mm-thick glass slide. One end of the optical fiber is attached to a device that permits rotation of the optical fiber in a controlled fashion. The optical fiber is examined in transmission under 100× magnification and rotated until the thickness of the high-modulus coating is equivalent on both sides of the glass fiber in a direction parallel to the glass slide. In this position, the thickness of the high-modulus coating is equal on both sides of the optical fiber in a direction parallel to the glass slide. The thickness of the high-modulus coating in the direction normal to the glass slide and above or below the glass fiber differed from the thickness of the high-modulus coating in the direction parallel to the glass slide. One of the thicknesses in the direction normal to the glass slide is greater and the other of the thicknesses in the direction normal to the glass slide is less than the thickness in the direction parallel to the glass slide. This position of the optical fiber is fixed by taping the optical fiber to the glass slide at both ends and is the position of the optical fiber used for the indentation test.

Indentation may be carried out using a universal testing machine (Instron model 5500R or equivalent). An inverted microscope is placed beneath the crosshead of the testing machine. The objective of the microscope was positioned directly beneath a Vickers diamond wedge indenter, with an included angle of 75°, that is installed in the testing machine. The glass slide with taped fiber is placed on the microscope stage and positioned directly beneath the indenter such that the width of the indenter wedge is orthogonal to the direction of the optical fiber. With the optical fiber in place, the diamond wedge is lowered until it contacts the surface of the high-modulus coating. The diamond wedge is then driven into the high-modulus coating at a rate of 0.1 mm/min and the load on the high-modulus coating is measured. The load on the high-modulus coating increases as the diamond wedge is driven deeper into the high-modulus coating until puncture occurs, at which point a precipitous decrease in load is observed. The indentation load at which puncture is observed is recorded and is reported as grams of force (g) and referred to as “puncture load”. The experiment is repeated with the optical fiber with the two-layer coating in the same orientation to obtain ten measurement points, which are averaged to determine a puncture load for the orientation. A second set of ten measurement points is taken by rotating the orientation of the optical fiber with the two-layer coating by 180°.

Puncture Resistance of a Coated Fiber to Determine Final Failure Puncture Load (“Modified Puncture Resistance Test”). Puncture resistance measurements can also be made on an optical fiber that includes a glass fiber and a three-layer coating comprising a first high-modulus coating, a second high modulus coating, and a low modulus coating as disclosed herein. The puncture resistance of the optical fiber with the three-layer coating can be measured using a modified version of the technique described in the article entitled “Quantifying the Puncture Resistance of Optical Fiber Coatings”, by G. Scott Glaesemann and Donald A. Clark, published in the Proceedings of the 52nd International Wire & Cable Symposium, pp. 237-245 (2003), as discussed above with reference to the traditional optical fiber. The modified puncture resistance test may also be performed on traditional two-layer optical fibers. For optical fibers having the low-modulus coating between the first and second high-modulus coatings, as discussed with reference to FIG. 1, the method remains the same as discussed above except for the indentation load at which puncture is observed, recorded, and referred to as “initial puncture load”. The diamond wedge is then driven until contact is made with the high-modulus inner coating. The diamond wedge is then driven into the high-modulus inner coating at a rate of 0.1 mm/min and the load on the high-modulus inner coating is measured. The load on the high-modulus coating increases as the diamond wedge is driven deeper into the high-modulus inner coating until the fiber completely pulls apart. The indentation load at which the fiber completely pulls apart is observed, recorded, and is reported as grams of force (g) and referred to as “final failure puncture load”.

For optical fibers having the low-modulus coating between the glass fiber and the second high-modulus coating, as discussed with reference to FIG. 3, and for traditional two-layer optical fibers, the method remains the same as discussed above except for the indentation load at which puncture is observed, recorded, and referred to as “initial puncture load”. The diamond wedge is then driven through the low-modulus coating until the fiber completely pulls apart. The indentation load at which the fiber completely pulls apart is observed, recorded, and is reported as grams of force (g) and referred to as “final failure puncture load”.

Referring again to both FIGS. 1 and 3, the optical fibers 10, 20 may have a final failure puncture load, as measured using the Modified Puncture Resistance Test, of at least about 25 g, or less than about 125 g, or between about 25 g and about 125 g. In various embodiments the final failure puncture load of the optical fibers 10, 20 is about 25 g, 27 g, about 29 g, about 30 g, about 33 g, about 35 g, about 38 g, about 40 g, about 42 g, about 45 g, about 48 g, about 50 g, about 55 g, about 60 g, about 65 g, about 70 g, about 75 g, about 80 g, about 85 g, about 90 g, about 95 g, about 100 g, about 105 g, about 110 g, about 113 g, about 115 g, about 117 g, about 120 g, about 121 g, about 123 g, about 125 g, about 127 g, or about 130 g, or within any range bound by any two of those values (e.g., from about 27 g to about 130 g, from about 40 g to about 113 g, from about 60 g to about 95 g, and so on).

Stress Triaxiality. The stress triaxiality of an optical fiber coating corresponds to the relative stress state of the coating, such that a coating with a relatively higher stress triaxiality tends to have a lower puncture resistance and is more prone to rupturing under compression as compared to a coating with a relatively lower stress triaxiality. As shown in Eq. (6) below, stress triaxiality can be calculated by dividing the mean stress σₘ (which is equal to one third of the summation of first principal stress σ₁, second principal stress σ₂, and third principal stress σ₂) by the equivalent stress σ_{eq}:

$$Stress triaxiality = \frac{{σ}_{m}}{{σ}_{eq}} = \frac{\frac{1}{3} ( {σ}_{1} + {σ}_{2} + {σ}_{3} )}{\sqrt{\frac{{( {σ}_{1} - {σ}_{2} )}^{2} + {( {σ}_{2} - {σ}_{3} )}^{2} + {( {σ}_{3} - {σ}_{1} )}^{2}}{2}}} \qquad ( 6 )$$

For purposes of the present disclosure, stress triaxiality is determined using the following process: first an optical fiber is positioned and the same Vickers diamond wedge indenter, as described above with reference to the puncture test, is vertically lowered until it contacts the surface of the fiber coating. The indenter is then driven into the fiber coating at a rate of 0.1 mm/min until puncture of the coating occurs and the load on the fiber coating is measured as grams of force (g).

Fiber Draw Process. The optical fibers disclosed herein may be formed from a continuous optical fiber manufacturing process for both embodiments described with reference to FIGS. 1 and 3, during which a glass fiber 11, 21 is drawn from a heated preform and sized to a target diameter. The glass fiber 11, 21 is then cooled and directed to a coating system that applies a first liquid coating composition 14, 24, either a liquid low-modulus coating composition 24 or a first liquid high-modulus coating composition 14, to the outer surface of the glass fiber 11, 21. Two process options are viable after application of the first liquid coating composition 14, 24 to the glass fiber 11, 21. In one process option (wet-on-dry process), the first liquid coating composition 14, 24 is cured to form a solidified first coating 14, 24, and a second liquid coating composition 16, 26, either a liquid low-modulus coating composition 16 or a first liquid high-modulus coating composition 26, is applied to the cured first coating 14, 24. In a second process option (wet-on-wet process), the second liquid coating composition 16, 26 is applied to the first liquid coating composition 14, 24.

After the second liquid coating composition application 16, 26, two more process options are viable. In a first process option (wet-on-dry process), the second liquid coating composition 16, 26 or both liquid coating compositions 14, 24, 16, 26 are cured to form a solidified second coating 16, 26. Then a third liquid coating composition 18, 28, a liquid second high-modulus coating composition 18, 28, is applied to the second coating 16, 26, and the third liquid coating 18, 28 is cured to form a solidified second high-modulus coating 18, 28. In a second process option (wet-on-wet process), the third liquid coating composition 18, 28 is applied to the second liquid composition 16, 26 and all liquid coating compositions, which may be the first, second, and third liquid coatings 14, 24, 16, 26, 18, 28 or the second and third liquid coatings 16, 26, 18, 28, are cured simultaneously to provide the solidified first, second, and third coatings 14, 24, 16, 26, 18, 28. After the coated fiber 10, 20 exits the coating system, the fiber is collected and stored at room temperature. Collection of the fiber typically entails winding the fiber on a spool and storing the spool.

In some processes, the coating system further applies a pigmented outer coating composition (not shown) to the second high-modulus coating 18, 28 and cures the pigmented outer coating composition to form a solidified pigmented outer coating (not shown). Typically, the pigmented outer coating is an ink layer used to mark the fiber for identification purposes and has a composition that includes a pigment and is otherwise similar to the second high-modulus coating 18, 28. The pigmented outer coating is applied to the second high-modulus coating 18, 28 and cured. The high-modulus coating 18, 28 has typically been cured at the time of application of the pigmented outer coating. The low-modulus 16, 24, first high-modulus 14, 26, second high-modulus 18, 28, and pigmented outer coating compositions can be applied and cured in a common continuous manufacturing process. Alternatively, the low-modulus 16, 24, the first high-modulus 14, 26, and second high-modulus coating compositions 18, 28 are applied and cured in a common continuous manufacturing process, the coated fiber 10, 20 is collected, and the pigmented outer coating composition is applied and cured in a separate offline process to form the pigmented outer coating.

Properties. The optical fibers disclosed herein, with coatings 14, 16, 18, 24, 26, 28 disposed thereon, have a mode field diameter, at 1310 nm wavelength, of about 8.2 μm or greater, or about 8.4 μm or greater, or about 8.6 μm or greater, or about 8.8 μm or greater, or about 8.9 μm or greater, or about 9.0 μm or greater, or about 9.1 μm or greater, or about 9.2 μm or greater, or about 9.3 μm or greater, or about 9.4 μm or greater, or about 9.5 μm or greater, or about 9.6 μm or greater, or about 9.7 μm or greater. In some embodiments, the mode field diameter is in a range from about 8.2 μm to about 9.7 μm, or from about 8.4 μm to about 9.5 microns, or from about 8.6 μm to about 9.4 μm, or from about 8.8 μm to about 9.4 μm. For example, the mode field diameter, at 1310 nm wavelength, is about 8.43 μm, or about 8.88 μm, or about 8.90 μm, or about 8.91 μm, or about 9.22 μm, or about 9.34 μm.

The optical fibers disclosed herein, with coatings 14, 16, 18, 24, 26, 28 disposed thereon, have a mode field diameter, at 1550 nm wavelength, of about 9.2 μm to about 11.0 μm, or about 9.4 μm to about 10.8 μm, or about 9.8 μm to about 10.6 μm, or about 10.0 μm to about 10.4 microns, or about 9.8 μm to about 10.4 μm. In some embodiments, the mode field diameter, at 1550 nm wavelength, is about 9.90 μm, or about 10.09 μm, or about 10.10 μm, or about 10.24 μm, or about 10.31 μm.

The cable cutoff of the optical fibers disclosed herein, with coatings 14, 16, 18, 24, 26, 28 disposed thereon, is about 1260 nm or less, or about 1250 nm or less, or about 1225 nm or less, or about 1200 nm or less, or about 1195 nm or less, or about 1190 nm or less, or about 1185 nm or less, or about 1180 nm or less, or about 1175 nm or less, or about 1170 nm or less, or about 1160 nm or less, or about 1150 nm or less, or about 1140 nm or less, or about 1140 nm or less, or about 1120 nm or less, or about 1110 nm or less, or about 1100 nm or less. For example, the cable cutoff is from about 1060 nm to about 1260 nm, or from about 1060 nm to about 1225 nm, or from about 1080 nm to about 1200 nm, or from about 1100 to about 1180 nm, or from about 1100 nm to about 1160 nm, or from about 1120 nm to about 1180 nm. In embodiments, the cable cutoff is about 1129 nm, or about 1133 nm, or about 1155 nm, or about 1178 nm.

Furthermore, the optical fibers disclosed herein, with coatings 14, 16, 18, 24, 26, 28 disposed thereon, have an effective area, at 1310 nm wavelength, of about 54.0 micron² or greater, or about 55.0 micron² or greater, or about 58.0 micron² or greater, or about 59.0 micron² or greater, or about 60.0 micron² or greater, or about 62.0 micron² or greater, or about 64.0 micron² or greater, or about 66.0 micron² or greater, or about 70.0 micron² or less, or about 69.0 micron² or less, or about 68.0 micron² or less, or about 67.0 micron² or less, or about 66.0 micron² or less, or about 65.0 micron² or less, or about 64.0 micron² or less, or about 62.0 micron² or less, or about 60.0 micron² or less, or about 58.0 micron² or less, or about 56.0 micron² or less. In some embodiments, the effective area, at 1310 nm wavelength, is in range between about 54.0 micron² and about 70.0 micron², or about 58.0 micron² to about 68.0 micron², or about 60.0 micron² to about 66.0 micron². The optical fibers also have an effective area, at 1550 nm wavelength, of about 75 micron² or greater, or about 78 micron² or greater, or about 80 micron² or greater, or about 82 micron² or greater, or about 85 micron² or greater, or about 87 micron² or greater. Additionally or alternatively, the effective area, at 1550 nm wavelength, is about 95 micron² or less, or about 90 micron² or less, or about 85 micron² or less. In some embodiments, the effective area, at 1550 nm wavelength, is in range between about 75 micron² and about 90 micron².

The optical fibers disclosed herein, with coatings 14, 16, 18, 24, 26, 28 disposed thereon, also have zero dispersion wavelength (λ₀) from about 1290 nm to about 1330 nm. For example, the zero dispersion wavelength can be from about 1295 nm to about 1325 nm, about 1300 nm to about 1324 nm, or from about 1305 nm to about 1315 nm. For example, the zero dispersion wavelength can be about 1280 nm, about 1285 nm, about 1289 nm, about 1290 nm, about 1300 nm, about 1301 nm, about 1305 nm, about 1306 nm, about 1310 nm, about 1315 nm, or about 1320 nm.

Additionally, the attenuation of the optical fibers disclosed herein, with coatings 14, 16, 18, 24, 26, 28 disposed thereon and at 1310 nm wavelength, is less than or equal to about 0.50 dB/km, or less than or equal to about 0.45 dB/km, or less than or equal to about 0.40 dB/km, or less than or equal to about 0.35 dB/km, or less than or equal to about 0.30 dB/km, or less than or equal to about 0.25 dB/km. Additionally or alternatively, the attenuation at 1310 nm wavelength is about 0.25 dB/km or greater, or about 0.30 dB/km or greater, or about 0.35 dB/km or greater, or about 0.40 dB/km or greater, or about 0.45 dB/km or greater. In embodiments, the attenuation at 1310 nm is in a range from about 0.50 dB/km to about 0.25 dB/km, or from about 0.45 dB/km to about 0.30 dB/km, or from about 0.40 dB/km to about 0.35 dB/km. Furthermore, the attenuation of the optical fibers with coatings 14, 16, 18, 24, 26, 28 disposed thereon and at 1550 nm wavelength, is less than or equal to about 0.50 dB/km, or less than or equal to about 0.45 dB/km, or less than or equal to about 0.40 dB/km, or less than or equal to about 0.35 dB/km, or less than or equal to about 0.30 dB/km, or less than or equal to about 0.25 dB/km, or less than or equal to about 0.20 dB/km, or less than or equal to about 0.15 dB/km. Additionally or alternatively, the attenuation at 1550 nm wavelength is about 0.15 dB/km or greater, or about 0.20 dB/km or greater, or about 0.25 dB/km or greater, or about 0.30 dB/km or greater, or about 0.35 dB/km or greater, or about 0.40 dB/km or greater, or about 0.45 dB/km or greater. In embodiments, the attenuation at 1550 nm is in a range from about 0.50 dB/km to about 0.15 dB/km, or from about 0.45 dB/km to about 0.20 dB/km, or from about 0.40 dB/km to about 0.25 dB/km.

According to aspects of the present disclosure, the optical fibers disclosed herein, with coatings 14, 16, 18, 24, 26, 28 disposed thereon, have a dispersion at 1310 nm in a range between about −1.5 ps/nm/km and about 1.5 ps/nm/km and a dispersion slope at 1310 nm in a range between about 0.05 ps/nm²/km and 0.1 ps/nm²/km. For example, the dispersion at 1310 nm is from about −1.2 ps/nm/km to about 1.2 ps/nm/km, or about −1.0 ps/nm/km to about 1.0 ps/nm/km. For example, the dispersion at 1310 nm is about −1.1 ps/nm/km, or about −0.8 ps/nm/km, or about −0.7 ps/nm/km, or about −0.4 ps/nm/km, or about −0.3 ps/nm/km, or about 0.1 ps/nm/km, or about 0.2 ps/nm/km. In some examples, the dispersion slope at 1310 nm is about 0.05 ps/nm²/km to about 0.095 ps/nm²/km, or about 0.06 ps/nm²/km to about 0.1 ps/nm²/km, about 0.07 ps/nm²/km to about 0.1 ps/nm²/km, about 0.08 ps/nm²/km to about 0.1 ps/nm²/km.

### EXAMPLES

Several illustrative optical fibers with three coating layers were prepared as described with reference to FIG. 1 and an illustrative optical fiber with three coating layers was prepared as described with reference to FIG. 2. A comparative example of a two-layer coated optical fiber was also prepared. The initial puncture load and final failure puncture load were tested and recorded.

Profile Parameters and Measured Optical Parameters. Table 6 shows profile parameters and measured optical parameters for Comparative Example 1 (CE1) and Exemplary Examples 1-4 (E1 to E4). CE1 is a fiber with a graded index profile core design and an up-doped cladding. E1 to E4 are fibers with a step index core and a pure silica cladding. The mode filed diameters (MFD) and cable cutoff wavelengths are compatible with the standard single mode fibers. The fiber attenuation is also similar to standard single mode fibers.

TABLE 6
Profile Parameters and Measured Optical Parameters

| | CE1 | E1 | E2 | E3 | E4 |
|---|---|---|---|---|---|
| Core delta Δ₁ (%) | 0.425 | 0.34 | 0.33 | 0.32 | 0.35 |
| Core alpha | 2.3 | 7.5 | 8.5 | 5.5 | 7.5 |
| Core radius r₁ (μm) | 5.8 | 5.0 | 4.6 | 4.5 | 4.7 |
| Inner cladding delta Δ₂ (%) | 0 | 0 | 0 | 0 | 0 |
| Inner cladding radius r₂ (μm) | 13.7 | na | na | na | na |
| Trench delta Δ₃ (%) | na | na | na | na | na |
| Trench radius r₃ (μm) | na | na | na | na | na |
| Outer cladding delta Δ₄ (%) | 0.021 | 0 | 0 | 0 | 0 |
| Outer cladding radius r₂ (μm) | 62.5 | 57.5 | 57 | 55.5 | 62.5 |
| Cable cutoff (nm) | 1180 | 1074 | 1120 | 990 | 1160 |
| MFD at 1310 nm (mm) | 9.1 | 9.3 | 9.4 | 9.6 | 9.2 |
| MFD at 1550 nm (mm) | 10.2 | 10.7 | 10.6 | 11.0 | 10.4 |
| Attenuation at | 0.334 | 0.321 | 0.338 | 0.368 | 0.451 |
| 1310 nm (dB/km) | | | | | |
| Attenuation at | 0.188 | 0.227 | 0.197 | 0.441 | 0.363 |
| 1550 nm (dB/km) | | | | | |

### Comparative Example 1

The comparative two-layer coated optical fiber was prepared according to the specifications shown in Table 7. The traditional puncture resistance test was performed on Comparative Example 1 (CE1) and the resulting puncture load is shown in Table 7. The modified puncture resistance test was also performed on CE1 and the resulting final failure puncture load is also shown in Table 7.

TABLE 7
Comparative Example 1 Specifications and Test Results

| | CE1 |
|---|---|
| Glass Fiber Profile | Graded Index Core, |
| | Dual Cladding |
| Glass Fiber Diameter (μm) | 125 |
| Inner Primary Coating Composition | Low Modulus Coating |
| Inner Primary Coating Thickness (μm) | 32.5 |
| Inner Primary Coating Diameter (μm) | 190 |
| Outer Secondary Coating Composition | High Modulus Coating A |
| Outer Secondary Coating Thickness (μm) | 26.5 |
| Outside Diameter (μm) | 243 |
| Puncture Load - Traditional Puncture | 55-60 |
| Resistance Test (g) | |
| Initial Puncture Load - Modified Puncture | 55-60 |
| Resistance Test (g) | |
| Final Failure Puncture Load - Modified | 70 |
| Puncture Resistance Test (g) | |

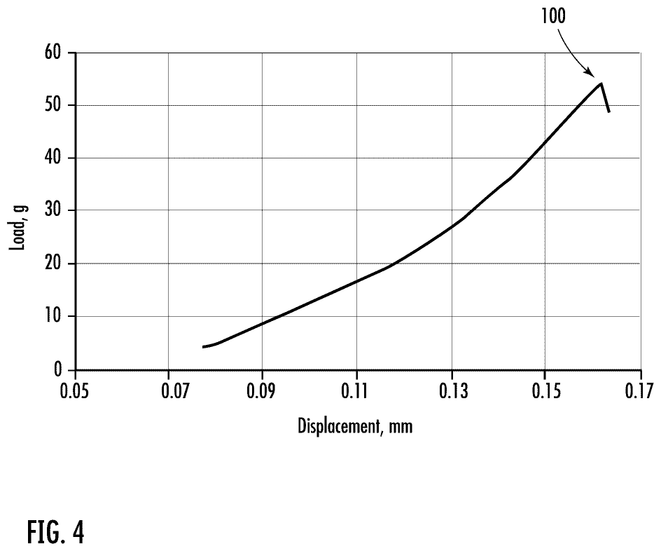

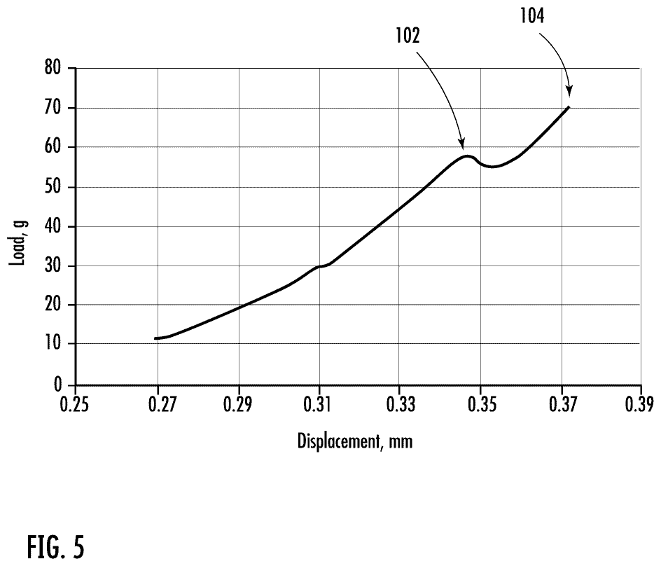

FIGS. 4 and 5 show load curves produced during the traditional puncture resistance test and the modified puncture resistance test for Comparative Example 1. The load curve shown in FIG. 4 was produced during the traditional puncture resistance test and the puncture load for CE1 is located at peak 100. The load curve shown in FIG. 5 was produced during the modified puncture resistance test and the initial puncture load for CE1 is located at peak 102 and the final failure puncture load for CE1 is located at point 104.

### Exemplary Examples E1-E3

Exemplary Examples E1, E2, E3 are each a three-layer coated optical fiber prepared in configurations as described with reference to FIG. 1 and with reference to the specifications shown in Table 8. The modified puncture resistance test was performed on each of the exemplary examples and the “initial puncture load” and the “final failure puncture load” are shown in Table 8.

TABLE 8
Exemplary Examples E1-E3

| | E1 | E2 | E3 |
|---|---|---|---|
| Glass Fiber | Step Index | Step Index | Step Index |
| Profile | Core, | Core, | Core, |
| | Single | Single | Single |
| | Cladding | Cladding | Cladding |
| Glass Fiber | 115 | 114 | 111 |
| Diameter (μm) | | | |
| First High-Modulus | High | High | High |
| Coating | Modulus | Modulus | Modulus |
| Composition | Coating A | Coating A | Coating E |
| | | w/1 pph | w/2 pph |
| | | acryl silane | thiol silane |
| First High-Modulus | 5.5 | 5.5 | 7 |
| Coating Thickness (μm) | | | |
| First High-Modulus | 126 | 125 | 125 |
| Coating Diameter (μm) | | | |
| Low-Modulus Coating | LMC | LMC | LMC |
| Composition | | | |
| Low-Modulus Coating | 9 | 10 | 10 |
| Thickness (μm) | | | |
| Low-Modulus Coating | 144 | 145 | 145 |
| Diameter (μm) | | | |
| Second High-Modulus | High | High | High |
| Coating Composition | Modulus | Modulus | Modulus |
| | Coating A | Coating A | Coating A |
| Second High-Modulus | 8.5 | 7.5 | 10 |
| Coating Thickness (μm) | | | |
| Outside Diameter (μm) | 161 | 160 | 165 |
| Initial Puncture Load (g) | 15 | 18-20 | 15 |
| Final Failure | 30-40 | 60-70 | 80-90 |
| Puncture Load (g) | | | |

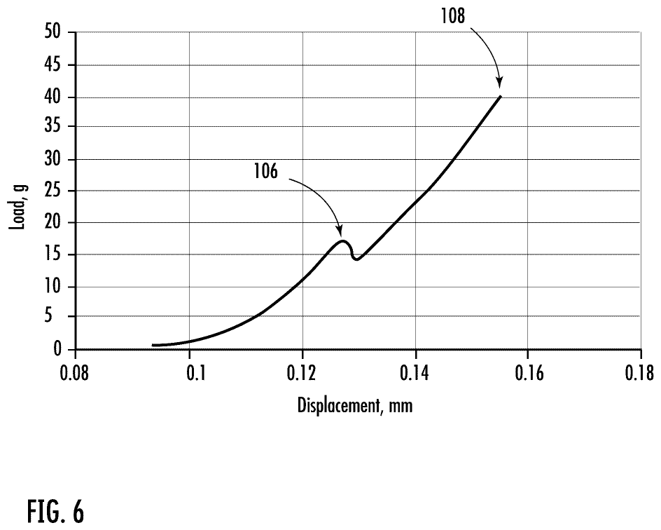

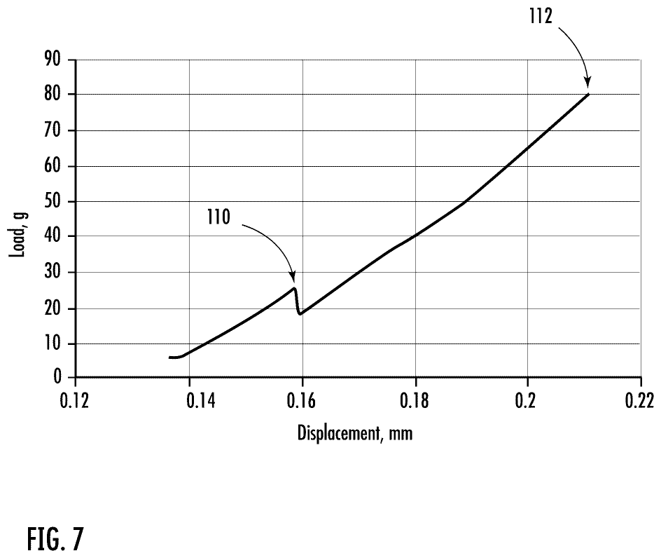

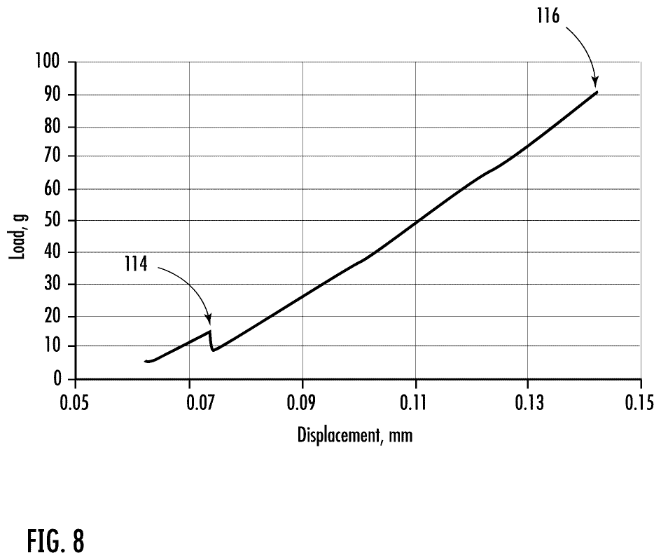

FIG. 6 shows a load curve produced during the modified puncture resistance test for Exemplary Example E1. The initial puncture load is located at peak 106 and the final failure puncture load is located at point 110 for E1. FIG. 7 shows a load curve produced during the modified puncture resistance test for Exemplary Example E2. The initial puncture load is located at peak 110 and the final failure puncture load is located at point 112 for E2. FIG. 8 shows a load curve produced during the modified puncture resistance test for Exemplary Example E3. The initial puncture load is located at peak 114 and the final failure puncture load is located at point 116 for E3.

With reference to FIGS. 4-8 and Tables 7 and 8, E1 and E2 had a similar initial puncture load. However, the final failure puncture load for E2 nearly doubles the final failure puncture load for E1 due to the addition of the adhesion promoter (2 pph acryl silane) in the first high-modulus coating of E2. E3 showed a higher final failure puncture load than E2 because the first high-modulus coating of E3 had a higher Young's modulus than the first high-modulus coating of E2. Overall, E2 and E3 showed similar or higher final fiber failure load compared to the dual-layer traditional fiber CE1 even though they had a much smaller diameter, 160-165 μm vs. 243 μm. The similarity in final failure puncture load for E2 and E3 with CE1 is due to a difference in puncture mechanism between puncturing through the first high-modulus coatings surrounding the glass fiber, as in E2 and E3, versus through the one high modulus coating surrounding the one low-modulus coating, as in CE1.

### Exemplary Example E4

Exemplary Example E4 is a three-layer coated optical fiber prepared in a configuration as described with reference to FIG. 3 and with reference to the specifications shown in Table 9. The modified puncture resistance test was performed on Exemplary Example E4 and the “initial puncture load” and the “final failure puncture load” are shown in Table 9.

TABLE 9
Exemplary Example E4

| | E4 |
|---|---|
| Glass Fiber Profile | Step Index Core, |
| | Single Cladding |
| Glass Fiber Diameter (μm) | 125 |
| Low-Modulus Coating Composition | LMC |
| Low-Modulus Coating Thickness (μm) | 5.5 |
| Low-Modulus Coating Diameter (μm) | 136 |
| First High-Modulus Coating Composition | High Modulus Coating A |
| First High-Modulus Coating Thickness (μm) | 7 |
| First High-Modulus Coating Diameter (μm) | 150 |
| Second High-Modulus Coating Composition | High Modulus Coating E |
| Second High-Modulus Coating Thickness | 9 |
| (μm) | |
| Outside Diameter (μm) | 168 |
| Initial Puncture Load (g) | 45 |
| Final Failure Puncture Load (g) | 60 |

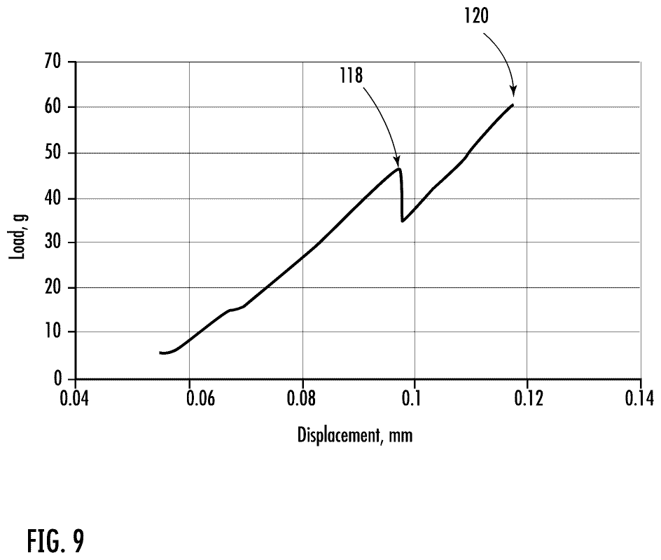

FIG. 9 shows a load curve produced during the modified puncture resistance test for Exemplary Example 4. The initial puncture load is located at peak 118 and the final failure puncture load is located at point 120 for E3.

With reference to FIGS. 5 and 9, and Tables 7 and 9, E4 had a significantly smaller outside diameter, 168 μm, than CE1 with an outside diameter of 243 μm. E4 and CE1 had similar initial puncture load and final failure puncture load despite the difference in outside diameter. The increase in initial puncture load and final failure puncture load for E4 is due to a difference in puncture mechanism between puncturing through two high-modulus coatings, as in E4, versus through only one high modulus coating, as in CE1.

Table 10 shows profile parameters and measured optical parameters for Comparative Example 2 (CE2) and Exemplary Example 5 (E5). CE2 is a fiber with a graded index profile core design and an up-doped cladding, and E5 is a fiber with a step index core and a pure silica cladding. The mode filed diameters (MFD) and cable cutoff wavelengths are compatible with the standard single mode fibers. The fiber attenuation is also similar to standard single mode fibers.

TABLE 10
Profile Parameters and Measured Optical Parameters

| | CE2 | E5 |
|---|---|---|
| Core delta Δ₁ (%) | 0.425 | 0.34 |
| Core alpha | 2.3 | 7.5 |
| Core radius r₁ (μm) | 5.8 | 5.0 |
| Inner cladding delta Δ₂ (%) | 0 | 0 |
| Inner cladding radius r₂ (μm) | 13.7 | na |
| Trench delta Δ₃ (%) | na | na |
| Trench radius r₃ (μm) | na | na |
| Outer cladding delta Δ₄ (%) | 0.021 | 0 |
| Outer cladding radius r₂ (μm) | 62.5 | 57.5 |
| Cable cutoff (nm) | 1190 | 1170 |
| MFD at 1310 nm (mm) | 9.0 | 9.3 |
| MFD at 1550 nm (mm) | 10.2 | 10.7 |
| Attenuation at 1310 nm (dB/km) | 0.33 | 0.36 |
| Attenuation at 1550 nm (dB/km) | 0.19 | 0.22 |

The Comparative Example 2 (CE2) was a two-layer coated optical fiber having the specifications shown in Table 11.

TABLE 11
Comparative Example 2 Specifications and Test Results

| | CE2 |
|---|---|
| Glass Fiber Profile | Graded Index Core, Dual |
| | Cladding |
| Glass Fiber Diameter (μm) | 125 |
| Inner Primary Coating Composition | Low Modulus Coating |
| Inner Primary Coating Thickness (μm) | 7.5 |
| Inner Primary Coating Diameter (μm) | 140 |
| Outer Secondary Coating Composition | High Modulus Coating A |
| Outer Secondary Coating Thickness (μm) | 10 |
| Outside Diameter (μm) | 160 |
| Puncture Load - Traditional Puncture | 10-15 |
| Resistance Test (g) | |
| Initial Puncture Load - Modified Puncture | 10-15 |
| Resistance Test (g) | |
| Final Failure Puncture Load - Modified | 30 |
| Puncture Resistance Test (g) | |

The Exemplary Example 5 (E5) was a three-layer coated optical fiber having the specifications shown in Table 12:

TABLE 12
Exemplary Example E5

| | E5 |
|---|---|
| Glass Fiber Profile | Step Index Core, |
| | Single Cladding |
| Glass Fiber Diameter (μm) | 115 |
| First High-Modulus Coating | High Modulus |
| Composition | Coating A |
| First High-Modulus Coating | 5 |
| Thickness (μm) | |
| First High-Modulus Coating Diameter | 125 |
| (μm) | |
| Low-Modulus Coating Composition | LMC |
| Low-Modulus Coating Thickness | 7.5 |
| (μm) | |
| Low-Modulus Coating Diameter (μm) | 140 |
| Second High-Modulus Coating | High Modulus |
| Composition | Coating A |
| Second High-Modulus Coating | 10 |
| Thickness (μm) | |
| Outside Diameter (μm) | 160 |
| Initial Puncture Load (g) | 15 |
| Final Failure Puncture Load (g) | 80 |

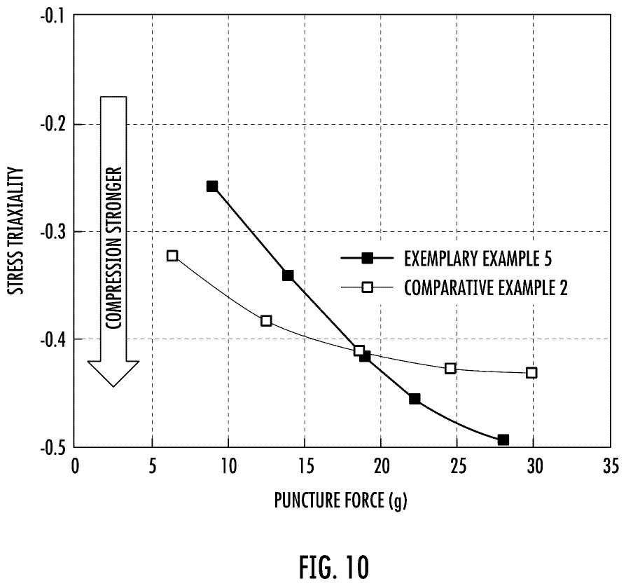

FIG. 10 shows the stress triaxiality results for the Comparative Example 2 (CE2) and the Exemplary Example 5 (E5). As shown in FIG. 10, the coating of E5 has an overall smaller stress triaxiality and a faster decreasing rate of stress triaxiality as compared to the coating of CE2, showing that the coating of E5 is harder to rupture than that of CE2. More specifically, in the fiber of E5, the first high-modulus coating layer is positioned on the glass cladding. The glass cladding provides supports to the first high-modulus coating layer so that it is harder to bend and deform the first high-modulus coating layer of E5. In contrast, in the fiber of CE2, the low-modulus coating layer is positioned on the glass cladding so that the high-modulus coating layer of CE2 is able to bend and deform to a greater extent. Consequently, the first high-modulus coating layer of E5 experiences a lower level of bending compared to the high-modulus coating layer of CE2. Lower level of bending deformation helps to decrease stress triaxiality in the puncture region. Therefore, the coating of E5 has a relatively smaller stress triaxiality than that of CE2 and, thus, a better rupture resistance.

It will be apparent to those skilled in the art that various modifications and variations can be made without departing from the spirit or scope of the claims.

What is claimed is:

1. An optical fiber, comprising:
a glass core;
a glass cladding surrounding and in direct contact with the glass core; and
a coating surrounding and in direct contact with the glass cladding, the coating including:
a first high-modulus coating layer having a Young's modulus greater than 500 MPa;
a second high-modulus coating layer having a Young's modulus greater than 500 MPa; and
a low-modulus coating layer having a Young's modulus between about 0.20 MPa and 5 MPa,
wherein an outer circumference of the optical fiber has a diameter less than about 200 μm.

2. The optical fiber of claim 1, wherein the outer circumference of the optical fiber has a diameter of less than about 180 μm.

3. The optical fiber of claim 2, wherein the outer circumference of the optical fiber has a diameter from about 160 μm to about 170 μm.

4. The optical fiber of claim 1, wherein at least one of the first high-modulus coating layer, the second high-modulus coating layer, and the low-modulus coating layer is a radially innermost coating layer that is directly adjacent the glass cladding, the radially innermost coating layer being the thinnest coating layer.

5. The optical fiber of claim 1, wherein the optical fiber has an attenuation at 1310 nm wavelength of about 0.50 dB/km or less and a cable cutoff of about 1260 nm or less.

6. The optical fiber of claim 5, wherein the attenuation at 1310 nm wavelength is about 0.40 dB/km or less.

7. The optical fiber of claim 6, wherein the attenuation at 1310 nm wavelength is about 0.35 dB/km or less.

8. The optical fiber of claim 5, wherein the attenuation at 1310 nm wavelength is from about 0.50 dB/km to about 0.25 dB/km.

9. The optical fiber of claim 5, wherein the cable cutoff is about 1225 nm or less.

10. The optical fiber of claim 5, wherein the optical fiber has an attenuation at 1550 nm wavelength of about 0.50 dB/km or less.

11. The optical fiber of claim 10, wherein the attenuation at 1550 nm wavelength is about 0.30 dB/km or less.

12. The optical fiber of claim 11, wherein the attenuation at 1550 nm wavelength is about 0.25 dB/km or less.

13. The optical fiber of claim 10, wherein the attenuation at 1550 nm wavelength is from about 0.50 dB/km to about 0.15 dB/km.

14. The optical fiber of claim 1, wherein the optical fiber has a mode field diameter at 1310 nm wavelength of about 8.2 μm or greater.

15. The optical fiber of claim 14, wherein the mode field diameter at 1310 nm wavelength is from about 8.2 μm to about 9.7 μm.

16. The optical fiber of claim 1, wherein the optical fiber has an effective area at 1310 nm wavelength from about 54.0 micron² to about 70.0 micron².

17. The optical fiber of claim 16, wherein the effective area at 1310 nm wavelength is from about 58.0 micron² to about 68.0 micron².

18. The optical fiber of claim 1, wherein the first high-modulus coating layer is surrounding and in direct contact with the glass cladding, the low-modulus coating layer is surrounding and in direct contact with the first high-modulus coating layer, and the second high-modulus coating layer is surrounding and in direct contact with the low-modulus coating layer.

19. The optical fiber of claim 18, wherein the first high-modulus coating layer has a thickness of less than about 10 μm, the low-modulus coating layer has a thickness of less than about 17.5 μm, and the second high-modulus coating layer has a thickness of less than about 25 μm.

20. The optical fiber of claim 18, wherein the first high-modulus coating layer comprises a cured product that includes a monomer, a photoinitiator, a slip agent, and an adhesion promoter.
